(19) United States
(12) Patent Application Publication
(10) Pub. No.: US 2013/0107685 A1
(43) Pub. Date: May 2, 2013

(54) OPTICAL DISC DEVICE

(71) Applicant: Sony Corporation, Tokyo (JP)

(72) Inventors: Kazuhiko Nemoto, Kanagawa (JP); Yusuke Ogawa, Tokyo (JP); Tamotsu Ishii, Chiba (JP)

(73) Assignee: Sony Corporation, Tokyo (JP)

(21) Appl. No.: 13/658,850

(22) Filed: Oct. 24, 2012

(30) Foreign Application Priority Data
Oct. 31, 2011 (JP) 2011-238469

(51) Int. Cl. G11B 7/09

(52) U.S. Cl. CPC G11B 7/0912; G11B 7/0917
USPC 369/47.44; 369/53.28

(57) ABSTRACT

An optical disc device includes: a diffraction element receiving as input reflected light from an optical disc recording medium, including a first diffraction area formed in a position where light in the center portion of incident light flux is diffracted, a second diffraction area formed so as to be in contact with an outer edge of the first diffraction area, and a third diffraction area formed so as to be in contact with an outer edge of the second diffraction area; and a light receiving/signal generating unit which generates a focus error signal and a lens error signal based on light diffracted at the third diffraction area; with the light receiving/signal generating unit receiving light diffracted at the second diffraction area, and generating the focus error signal based on the received light signal thereof and a received light signal obtained by receiving light diffracted at the third diffraction area.

### BACKGROUND

The present technology relates to an optical disc device which performs recording or playing as to an optical disc recording medium.

For example, as disclosed in Japanese Unexamined Patent Application Publication No. 2010-146607, there has been a configuration wherein both of detection of a focus error signal according to a spot size method, and detection of a signal according to tracking servo such as a lens error signal or the like are performed using a shared detector.

With such a configuration, an HOE (Holographic Optical Element) configured to have cylindrical lens effects is used, e.g., regarding a focal position in the tangential direction thereof (direction corresponding to the longitudinal direction of tracks formed in an optical disc recording medium) to generate light having a focal position on the nearer side of the light-receiving surface (hereafter, also referred to as nearer-side focal light) and light having a focal position on the deeper side (also referred to as deeper-side focal light).

Light having a different focal position depending on the nearer side or deeper side as to the light-receiving surface is used in this way, whereby a focus error signal according to a so-called spot size method can be generated.

In this case, with the above-mentioned HOE, for example, four diffraction areas are split-formed, and the light of each different portion within light flux can be split-received. A signal according to tracking servo such as a lens error signal or the like can be generated using light to be split-received in this way. Note that the lens error signal is a signal representing shift amount in the tracking direction (radial direction) of an objective lens.

Incidentally, with regard to an optical disc recording medium (hereafter, also simply referred to as optical disc), there has been proposed a recording medium having two recording layers to realize large recording capacity.

With such a two-layer disc, reflected light from a nearer side recording layer than a recording layer to be recorded/played may be received as stray light, which causes deterioration in C/N (carrier-to-noise ratio).

Therefore, in order to handle an optical disc having multiple recording layers, there has been developed an arrangement in which a mask diffraction area to scatter stray light to a location other than a light-receiving element is provided to the above-mentioned HOE, and light in a predetermined position within light flux to be guided to a light-receiving unit is removed (irradiation to a light-receiving element is suppressed).

Specifically, the center portion (the center portion of light flux) of the HOE is principally subjected to masking to remove stray light (e.g., see solid portions illustrated in FIG. 20).

Note that the reason why the center portion of light flux is taken as the formation position of the mask diffraction area is because stray light with a shallow incident angle which greatly contributes to deterioration in C/N can effectively be removed (e.g., see FIG. 8).

Incidentally, in recent years, in order to realize further large recording capacity, multi-layer discs having three or more recording layers have been developed and have also come into practical use.

In the case of multi-layer discs, the number of recording layers other than a recording layer to be processed increases as compared to two-layer discs, and accordingly, generation modes of stray light become diversified. In other words, stray light with various angles and various optical path lengths is generated, which leads to further deterioration in C/N.

With a configuration wherein a focus error signal and a lens error signal are generated by split light reception employing the HOE, it has been found that the deterioration in quality of the lens error signal is particularly marked due to influence of stray light in multi-layer discs.

In order to suppress the quality deterioration of such a lens error signal, in order to handle multi-layer discs, measures to expand the mask diffraction area are employed. That is to say, suitable removal of stray light which increases along with the number of recording layers increasing can be realized by expanding the mask diffraction area.

### SUMMARY

However, in the event of having realized expansion of the mask diffraction area as described above as stray light measures for multi-layer discs, the quality deterioration of a lens signal error can be suppressed, but on the other hand, this causes a problem in that the quality of a focus error signal is deteriorated.

This means that components of the light flux center portion have to be removed to generate a suitable lens error signal, but are important to generate a focus error signal (spot size method).

Here, deterioration in a focus error signal specifically appears as waveform distortion of an S-letter signal (e.g., see FIG. 22). More specifically, relatively great distortion occurs on the waveform of an intermediate section of the S-letter signal (between positive/negative peaks), which makes, as a result thereof, it difficult to stably perform focus-on operation as to a desired recording layer, or causes deterioration in servo properties.

With a configuration to split-receive reflected light from an optical disc using a diffraction element such as an HOE or the like, and to detect of a focus error signal according to the spot size method, and a lens error signal from a received light signal thereof, it has been found to be desirable to realize suppression of quality deterioration in a lens error signal due to stray light regarding a multi-layer disc, and also simultaneously, to realize suppression of quality deterioration in a focus error signal (S-letter signal).

An embodiment of the present technology provides an optical disc device.

According to an embodiment, the optical disc device includes a diffraction element to which reflected light from an optical disc recording medium is input, including a first diffraction area formed in a position where light in the center portion of incident light flux is diffracted, a second diffraction area formed so as to be in contact with an outer edge of the first diffraction area, and a third diffraction area formed so as to be in contact with an outer edge of the second diffraction area.

The optical disc device also includes a light receiving/signal generating unit configured to perform generation of a focus error signal and generation of a lens error signal according to the spot size method based on light diffracted at the third diffraction area.

The light receiving/signal generating unit receives light diffracted at the second diffraction area, and performs generation of the focus error signal based on the received light signal thereof and a received light signal obtained by receiving light diffracted at the third diffraction area.

According to the above-mentioned configuration, the diffraction element to perform split light reception includes the first diffraction area positioned in the center portion, the second diffraction area adjacent to the outer edge thereof, and the third diffraction area adjacent to the further outer edge thereof. According to the first diffraction area disposed in the center portion, light of a light flux center portion which is important for suppression of stray light components can be scattered to a location other than light-receiving elements.

According to the second diffraction area adjacent to the outer edge of this first diffraction area, part of light of a portion heretofore masked as measures for stray light of a multi-layer disc can be scattered to a predetermined location. That is to say, this means, with regard to light near the light flux center portion which has heretofore been scattered to a location other than light-receiving elements for suppression of quality deterioration of a lens error signal accompanying handling multi-layer discs, to newly enable a part thereof to be used.

Moreover, with the present technology, according to the light receiving/signal generating unit, light diffracted at this second diffraction area is newly received, and based on the received light signal thereof and the received light signal of light diffracted at the third diffraction area, generation (computation) of a focus error signal according to the spot size method is performed.

In other words, with regard to light near the light flux center portion which has heretofore been scattered to a location other than light-receiving elements for suppression of quality deterioration of a lens error signal accompanying handling multi-layer discs, such a configuration as the present technology can be expressed as a configuration wherein part thereof is newly received, and the received light signal thereof is applied to computation of a focus error signal.

Computation of a focus error signal is performed using part of light of the light flux center portion which is important for generation of a focus error signal, and accordingly, improvement in a S-letter waveform is realized as compared to the related art. That is to say, as a result thereof, improvement in stability of focus-on operation is realized, and also improvement in servo properties is realized.

On the other hand, with regard to a lens error signal generating system, diffracted light according to the second diffraction area adjacent to the first diffraction area (mask diffraction area) can be prevented from being received at a light-receiving unit for lens error signal generation (i.e., the same effect as a mask is obtained), and accordingly, the same effect as a mask effect handing multi-layer discs according to the related art can be maintained, and accordingly, the same signal quality as the related art can be maintained regarding a lens error signal.

In this way, according to the present technology, suppression of quality deterioration of a lens error signal, and also suppression of deterioration in the S-letter waveform of a focus error signal can be realized.

According to the present technology, with a configuration wherein reflected light from an optical disc recording medium is split-received by the diffraction element, and detection of a focus error signal according to the spot size method and a lens error signal is performed from the received light signal thereof, both of suppression of quality deterioration of a lens error signal, and suppression of deterioration in the S-letter waveform of a focus error signal can be realized.

### BRIEF DESCRIPTION OF THE DRAWINGS

FIG. 1 is a diagram illustrating the configuration of an optical system included in an optical disc device serving as the basis of an embodiment;

FIG. 2 is a diagram illustrating the configuration of a signal generating system included in the optical disc device serving as the basis of an embodiment;

FIGS. 3A and 3B are diagrams illustrating a relation between a split beam pattern by a first beam splitting unit and a received light pattern by a first light-receiving unit;

FIGS. 4A through 4F are explanatory diagrams regarding outline of a focus error signal FE generating technique according to the spot size method to be realized by beam splitting (diffraction) of a second beam splitting unit;

FIGS. 5A through 5E are diagrams for describing an example of a split beam pattern of the second beam splitting unit for enabling generation of a focus error signal (spot size method), a lens error signal, and a push-pull signal;

FIG. 6 is a diagram for describing the internal configuration of the optical disc device serving as Embodiment 1 of a first embodiment;

FIG. 7 is a diagram for describing a scene of split light reception in the event of the first beam splitting unit serving as an HOE;

FIG. 8 is a diagram for describing operation by disposing a mask diffraction area in the light flux center portion in the light of stray light removal;

FIG. 9 is a diagram for describing the first beam splitting unit included in the optical disc device serving as Embodiment 1 of the first embodiment;

FIG. 10 is a diagram illustrating a specific configuration example of the first beam splitting unit included in the optical disc device serving as Embodiment 1 of the first embodiment;

FIG. 11 is a diagram illustrating a shape example (in the case of four splits) of the first beam splitting unit configured to facilitate metal mold manufacturing;

FIG. 12 is a diagram for describing a modification regarding Embodiment 1 of the first embodiment;

FIG. 13 is a diagram for describing the internal configuration of an optical disc device serving as Embodiment 2 of the first embodiment;

FIG. 14 is a diagram for describing the first beam splitting unit included in the optical disc device serving as Embodiment 2 of the first embodiment;

FIG. 15 is a diagram illustrating a specific configuration example of the first beam splitting unit included in the optical disc device serving as Embodiment 2 of the first embodiment;

FIG. 16 is a diagram illustrating a correspondence relation between a light-receiving element to be formed in a first light-receiving unit included in the optical disc device serving as Embodiment 2 of the first embodiment and the light-receiving spot position of each reflected light;

FIG. 17 is a diagram illustrating a shape example (in the case of six splits) of the first beam splitting unit configured to facilitate metal mold manufacturing;

FIG. 18 is a diagram illustrating a relation between the first beam splitting unit in the event of employing three beams in the case of Embodiment 1 of the first embodiment and the spot position of each beam, and a relation between each light-receiving element to be formed in the first light-receiving unit and the light-receiving spot position of each beam;

FIG. 19 is a diagram illustrating a relation between the first beam splitting unit in the event of employing three beams in the case of Embodiment 2 of the first embodiment and the spot position of each beam, and a relation between each light-receiving element to be formed in the first light-receiving unit and the light-receiving spot position of each beam;

FIG. 20 is a diagram illustrating a configuration example of the second beam splitting unit where a mask diffraction area for performing stray light removal to handle the case of a two-layer disc is formed;

FIGS. 21A and 21B are diagrams for describing a configuration example of the second beam splitting unit where a mask diffraction area for performing stray light removal to handle the case of a multi-layer disc is formed;

FIG. 22 is a diagram for describing distortion of a focus error signal in the event of providing a mask diffraction area to handle a multi-layer disc;

FIGS. 23A and 23B are diagrams for describing a focus error signal generating technique serving as Embodiment 1 of the second embodiment;

FIG. 24 is a diagram for describing a scene of improvement in the S-letter waveform of a focus error signal in the event of employing the focus error signal generating technique serving as the second embodiment;

FIGS. 25A and 25B are diagrams for describing a signal generating technique serving as Embodiment 2 of the second embodiment;

FIGS. 26A and 26B are diagrams illustrating a diffraction area formation pattern of the second beam splitting unit in order to handle three wavelengths of BD, DVD, and CD (FIG. 26A), a position relation between each light-receiving element to be formed in the second light-receiving unit and the light-receiving spot of diffracted light by the second beam splitting unit (FIG. 26B);

FIG. 27 is a diagram illustrating a position relation between each light-receiving element of the second light-receiving unit and the light-receiving spot of diffracted light by the second beam splitting unit in the event of reversing a position relation between a diffraction area A and a diffraction area BB, and a position relation between a diffraction area B and a diffraction area AA; and

FIG. 28 is a diagram for describing the internal configuration of an optical disc device serving as a modification including a laminated prism to which a multiplexing function is provided.

### DETAILED DESCRIPTION OF EMBODIMENTS

Hereafter, embodiments according to the present technology will be described.

Note that description will be made in the following sequence.

### 1. Configuration Serving as Basis of Embodiment

### 1-1. Configuration of Optical System

### 1-2. Configuration of Signal Generating System

### 1-3. Split Beam/Received Light Pattern and Specific Generating Technique of Various Types of Signals

### 2. First Embodiment

### 2-1. Embodiment 1

### 2-2. Embodiment 2

### 3. Second Embodiment

### 3-1. Mask Diffraction Area According to Related Art and Problem Thereof

### 3-2. Embodiment 1

### 3-3. Embodiment 2

### 4. Modification

### 1. Configuration Serving as Basis of Embodiment

### 1-1. Configuration of Optical System

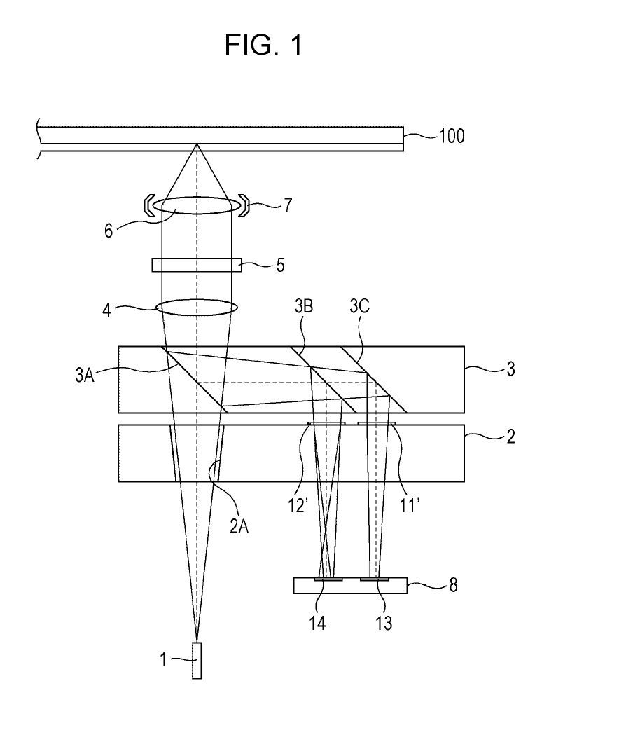

FIG. 1 is a diagram for describing the configuration of an optical disc device serving as the basis of the configuration of an optical disc device serving as an embodiment. Specifically, FIG. 1 principally illustrates the internal configuration of an optical pickup included in this optical disc device.

First, FIG. 1 illustrates an optical disc 100 which the optical disc device treats as a recording or playing object. Here, the optical disc 100 is taken as an optical disc recording medium, for example, such as BD (Blu-ray Disc (registered trademark)), DVD (Digital Versatile Disc), CD (Compact Disc) or the like. Here, the optical disc recording medium means a disc-shaped optical recording medium, and the optical recording medium generically names recording media where playing of a signal is performed by irradiation of light.

In the event that the optical disc 100 is taken as a ROM disk for only playing, information is recorded by a pit (embossed pit) being intermittently formed. A pit string made up of pits being intermittently formed in this way is formed in a spiral or concentric fashion on a recording surface as a recording track.

Also, in the event that the optical disc 100 is taken as a recordable disc (write-once type and rewritable type), a track made up of a groove (continuous groove) is formed on a recording surface in a spiral or concentric fashion.

Within the optical pickup, there is provided a laser 1 serving as a light source of light to be irradiated to perform recording/playing as to the optical disc 100. Also, within the optical pickup, as illustrated in the drawing, there are provided a compound lens 2, a laminated prism 3, a collimating lens 4, a quarter-wave plate 5, an objective lens 6, an actuator 7, and a light-receiving unit 8.

The compound lens 2 is formed of a transparent resin being subject to injection molding, and as illustrated in the drawing, has a generally rectangular parallel piped shape as a whole, and also a through hole 2A for transmitting the laser beam from the laser 1 is formed in a predetermined location thereof.

The laser beam transmitted through the through hole 2A is input to the laminated prism 3.

This laminated prism 3 is configured of a transparent resin being jointed via multiple joint areas, and has a generally rectangular parallel piped shape as a whole.

The films which transmit/reflect a laser beam with a predetermined transmittance/reflectance are formed on each joint face of the laminated prism 3. Specifically, these films are a polarization selective reflection film 3A, a half-reflection film 3B, and a total reflection film 3C in the drawing.

The laser beam emitted from the laser 1 and passed through the through hole 2A is input to the polarization selective reflection film 3A in the laminated prism 3.

The polarization selective reflection film 3A is configured to transmit/reflect incident light with transmittance/reflectance according to a polarized state. Specifically, with the present example, let us say that the polarization selective reflection film 3A is configured to transmit P polarization and to reflect S polarization.

With the laser beam input from the laser 1 side, a portion thereof is transmitted and a portion thereof is reflected at this polarization selective reflection film 3A.

The laser beam transmitted through the polarization selective reflection film 3A is converted so as to be changed from a divergent light state so far to a parallel light state by the collimating lens 4, and is input to the quarter-wave plate 5.

The laser beam passed through this quarter-wave plate 5 is input to the objective lens 6 held by the actuator 7, and thus, the laser beam is condensed in the recording surface of the optical disc 100.

The actuator 7 holds the objective lens 6 so as to be changed in a tracking direction (radial direction) which is a direction parallel to the radial direction of the optical disc 100, and in a focus direction which is a direction where the objective lens 6 comes into contact with/separates from the optical disc 100. The actuator 7 changes the objective lens 6 in the tracking direction and focus direction according to a tracking driving signal and a focus driving signal, respectively.

The reflected light from the optical disc 100 is, after passing through the objective lens 6 and quarter-wave plate 5, converted into convergence light at the collimating lens 4, and input to the polarization selective reflection film 3A.

Here, with the reflected light (return trip light) from the optical disc 100 to be input via the collimating lens 4 in this way, according to operation by the quarter-wave plate 5 and operation at the time of reflection at the optical disc 100 (recording surface), polarization direction thereof differs 90 degrees as to the polarization direction of the laser light (outward trip light) emitted from the laser 1 and emitted via the through hole 2A and polarization selective reflection film 3A (i.e., becomes S polarization in this case). Accordingly, the reflected light is reflected at the polarization selective reflection film 3A generally 100%, and is guided to the half-reflection film 3B as illustrated in the drawing.

The half-reflection film 3B reflects/transmits incident light with a predetermined percentage.

The light which transmitted the half-reflection film 3B is guided to the total reflection film 3C, and is reflected at this total reflection film 3C generally 100%.

The light reflected at the total reflection film 3C is input to a first beam splitting unit 11′ formed on the upper face side of the compound lens 2 (face side facing the laminated prism 3).

Also, the light reflected at the half-reflection film 3B is input to a second beam splitting unit 12′ similarly formed on the upper face side of the compound lens 2.

The first beam splitting unit 11′ splits the reflected light by the total reflection film 3C with a predetermined angle. As for this first beam splitting unit 11′, an HOE (Holographic Optical Element) is employed.

Note that a specific split beam pattern by the first beam splitting unit 11′ will be described later.

Also, the second beam splitting unit 12′ splits the reflected light by the half-reflection film 3B with a predetermined angle. Here, the HOE is also employed as the second beam splitting unit 12′.

Note that a specific split beam pattern by the second beam splitting unit 12′ will also be described later.

With the light-receiving unit 8, there are formed a first light-receiving unit 13 where multiple light-receiving elements which receive each light split by the first beam splitting unit 11′ are formed, and a second light-receiving unit 14 where multiple light-receiving elements which receive each light split by the second beam splitting unit 12′ are formed.

Note that light-receiving element formation patterns at the first light-receiving unit 13 and second light-receiving unit 14 will also be described later.

### 1-2. Configuration of Signal Generating System

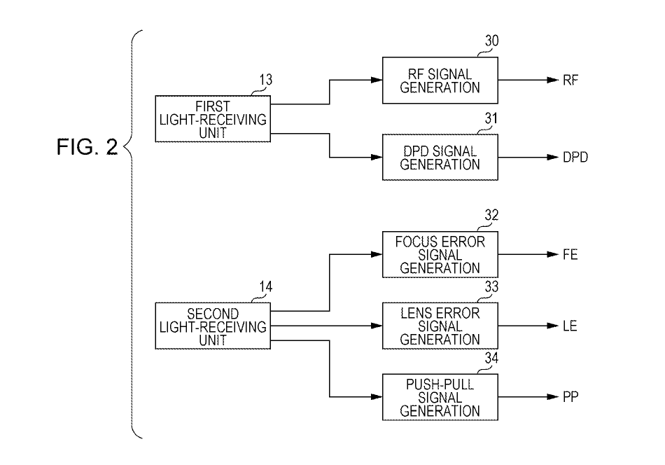

FIG. 2 is a diagram illustrating the configuration of a signal generating system included in the optical disc device serving as the basis of embodiments.

Note that, with this drawing, the first light-receiving unit 13 and second light-receiving unit 14 illustrated in FIG. 1 are also illustrated together.

As illustrated in the drawing, based on the received light signal by the first light-receiving unit 13, an RF signal is generated by an RF signal generating circuit 30. Specifically, the RF signal generating circuit 30 obtains the RF signal by computing summation of received light signals from the multiple light-receiving elements formed on the first light-receiving unit 13.

Also, based on the received light signal by the first light-receiving unit 13, a DPD signal (DPD: Differential Phase Detection) is generated by a DPD signal generating circuit 31.

On the other hand, based on the received light signal by the second light-receiving unit 14, a focus error signal (FE) according to the spot size method, a lens error signal (LE), and a push-pull signal (PP) are generated.

Specifically, with regard to the focus error signal FE, a focus error signal generating circuit 32 performs predetermined computation based on the received light signals from the multiple light-receiving elements formed on the second light-receiving unit 14 to generate the focus error signal FE.

Similarly, with regard to the lens error signal LE, a lens error signal generating circuit 33 performs predetermined computation based on the received light signals from the multiple light-receiving elements formed on the second light-receiving unit 14 to generate the lens error signal LE, and also, with regard to the push-pull signal PP, a push-pull signal generating circuit 34 performs predetermined computation based on the received light signals from the multiple light-receiving elements formed on the second light-receiving unit 14 to generate the push-pull signal PP.

Note that specific signal computation techniques by these focus error signal generating circuit 32, lens error signal generating circuit 33, and push-pull signal generating circuit 34 will be described later.

### 1-3. Split Beam/Received Light Pattern and Specific Generating Technique of Various Types of Signals

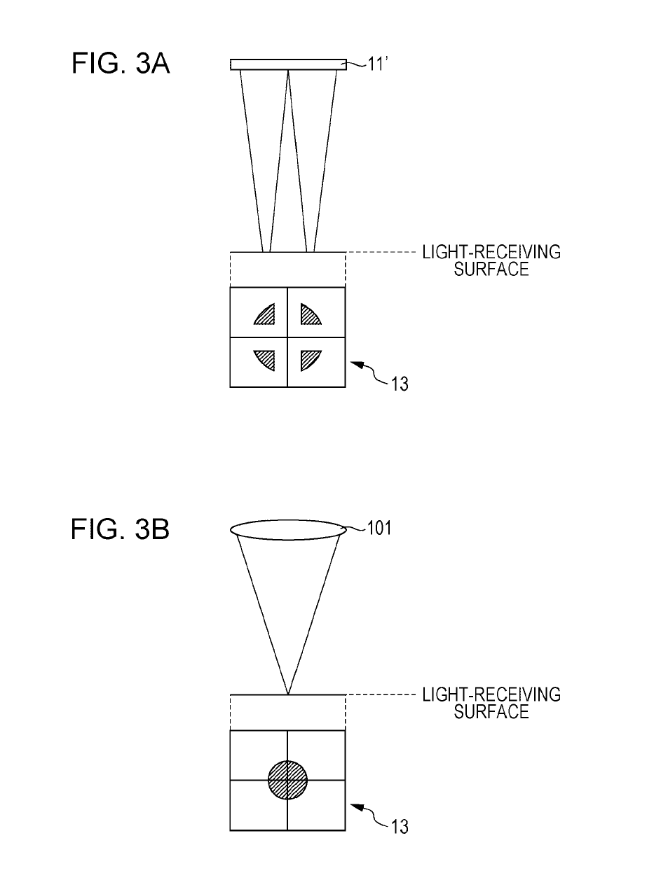

FIG. 3A is a diagram illustrating a relation between the split beam pattern by the first beam splitting unit 11′ and the received light pattern by the first light-receiving unit 13.

As illustrated in the drawing, incident light (reflected light by the total reflection film 3C) is split into four directions by the first beam splitting unit 11′.

The first light-receiving unit 13 in this case is taken as a four-split detector as illustrated in the drawing, where four light-receiving elements are formed. Four lights split and output by the first beam splitting unit 11′ are received by the light-receiving elements in the first light-receiving unit 13, respectively.

Incidentally, in order to realize such split light reception, as illustrated in FIG. 3B, a technique has widely been used wherein the reflected light from the optical disc 100 is condensed in the center portion of the first light-receiving unit 13 serving as a split detector by the condensing lens 101.

However, according to this technique, in order to realize suitable split light reception, the center of the split detector and the optical axis of reflected light have accurately to agree, and high position precision has to be satisfied correspondingly.

As illustrated in FIG. 3A, the reason why a configuration is employed wherein reflected light is split in front of the light-receiving surface is to realize easing of such position precision.

Specifically, according to a configuration wherein as described above, the first beam splitting unit 11′ is disposed to split reflected light in front of the light-receiving surface, and these are received at the light-receiving elements, even if error of the attachment position of the first beam splitting unit 11′ occurred, as compared to error amount thereof, the error amount of the light-receiving position of a beam on the light-receiving surface can be reduced small. Specifically, if we say that a ratio between the spot size on the first beam splitting unit 11′ and the spot size on the light-receiving surface is N:1, the shift amount of “1” on the first beam splitting unit 11′ can be reduced to “1/N” on the light-receiving surface. As a result thereof, easing of position precision is realized.

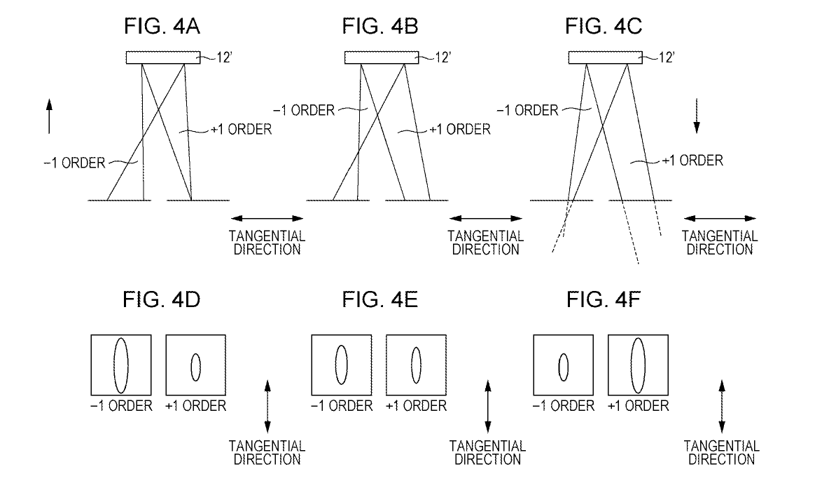

FIGS. 4A through 4F are explanatory diagrams regarding outline of the focus error signal FE generating technique according to the spot size method to be realized by beam splitting (diffraction) of the second beam splitting unit 12′.

First, as a premise, the HOE serving as the second beam splitting unit 12′ is configured so as to have a function serving as a cylindrical lens, whereby the tangential direction (direction equivalent to the longitudinal direction of tracks formed on the optical disc 100) of diffracted light thereof can be changed. Specifically, as illustrated in the drawing, the focal position of the tangential direction of +1 order light is taken as the deeper side of the light-receiving surface, and also, the focal position of the tangential direction of −1 order light is taken as the nearer side of the light-receiving surface.

With the spot size method in this case, +1 order light and −1 order light output from the second beam splitting unit 12′ are individually received, and these spot sizes are compared, thereby obtaining the focus error signal FE in this way.

Of FIGS. 4A through 4F, FIG. 4B illustrates a scene of diffracted light (±1 order light) by the second beam splitting unit 12′ in a state in which a laser beam to be irradiated on the optical disc 100 via the objective lens 6 is focused as to the recording surface, and FIG. 4E illustrates a scene of the light-receiving spots of +1 order light and −1 order light in the state illustrated in FIG. 4B.

Also, FIG. 4A illustrates a scene of ±1 order lights by the second beam splitting unit 12′ in a state in which the focal position of a laser beam to be irradiated on the optical disc 100 via the objective lens 6 is positioned on the deeper side of the recording surface, and FIG. 4D illustrates a scene of the light-receiving spots of +1 order light and −1 order light in the state illustrated in FIG. 4A.

Also, FIG. 4C illustrates a scene of ±1 order light by the second beam splitting unit 12′ in a state in which the focal position of a laser beam to be irradiated on the optical disc 100 via the objective lens 6 is positioned on the nearer side of the recording surface, and FIG. 4F illustrates a scene of the light-receiving spots of +1 order light and −1 order light in the state illustrated in FIG. 4C.

First, as illustrated in FIG. 4B, in this case, let us say that the second beam splitting unit 12′ is designed so that when a laser beam is in a focused state as to the recording surface, the focal position in the tangential direction of +1 order light thereof is the deeper side of the light-receiving surface, and the focal position −1 order light is the nearer side of the light-receiving surface.

Also, in the focused state illustrated in FIG. 4B, as illustrated in FIG. 4E, the light-receiving spot sizes of +1 order light and −1 order light of the second beam splitting unit 12′ are arranged to have the same size. In other words, the second beam splitting unit 12′ is designed so that the light-receiving spot sizes of +1 order light and −1 order light in the focused state have the same size in this way.

In the state illustrated in FIG. 4A, i.e., in a state in which the focal position is the deeper side of the recording surface, as illustrated in FIG. 4D, the light-receiving spot of +1 order light is reduced smaller than the focused state in FIG. 4E, and conversely, the light-receiving spot of −1 order light is expanded greater than the focused state in FIG. 4E.

On the other hand, in the state illustrated in FIG. 4C i.e., in a state in which the focal position is the nearer side of the recording surface, as illustrated in FIG. 4F, the light-receiving spot of +1 order light is expanded greater than the focused state in FIG. 4E, and as illustrated in FIG. 4F, the light-receiving spot of −1 order light is reduced smaller than the focused state in FIG. 4E.

With the spot size method in this case, difference between the light-receiving spot size of +1 order light and the light-receiving spot size of −1 order light, i.e., difference between the received light signal of +1 order light and the received light signal of −1 order light is calculated, thereby obtaining the focus error signal FE.

For example, specifically, if we say that the received light signal of +1 order light is D_p1, and the received light signal of −1 order light is D_m1, the focus error signal FE is obtained as follows.

FE=D_{—}p1−D_{—}m1

Thus, results are obtained, such as FE=0 in the focused state in FIG. 4B, FE=+at the time of the deeper side focus illustrated in FIG. 4A, and FE=—at the time of the nearer side defocus in FIG. 4C, it can be found that the suitable focus error signal FE is generated.

Note that a technique to generate the focus error signal FE according to the spot size method by providing a cylindrical lens effect to the HOE disposed in front of the light-receiving surface has also been disclosed in previously referenced in Japanese Unexamined Patent Application Publication No. 2010-146607 or the like.

Now, as can be understood with reference to the previous FIG. 2, with the present example, according to split light reception employing the second beam splitting unit 12′, both of generation of the focus error signal FE according to the spot size method as described above, and generation of the lens error signal LE and the push-pull signal PP are arranged to be performed.

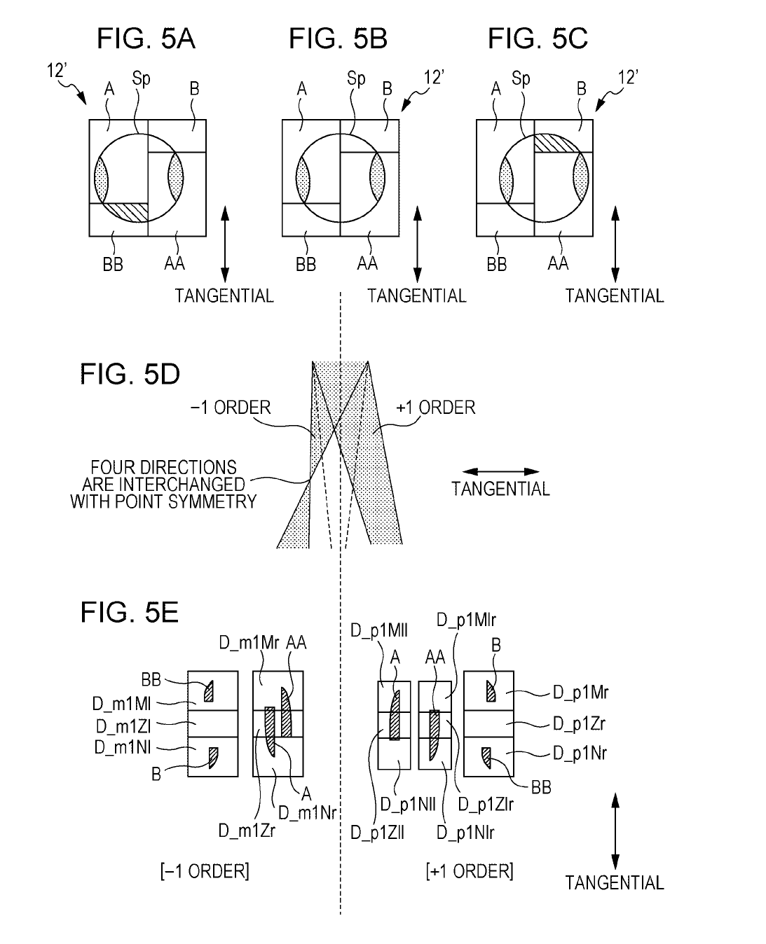

Hereafter, an example of the split beam patterns of the second beam splitting unit 12′ to enable generation of these focus error signal FE, lens error sign LE, and push-pull signal PP will be described with reference to FIGS. 5A through 5E.

First, of FIGS. 5A through 5E, the split beam patterns of the second beam splitting unit 12′ in this case are illustrated in the drawings in FIGS. 5A through 5C.

Specifically, the second beam splitting unit 12′ in this case is split into two prominent areas in the radial direction by a split line along the tangential direction. These two areas split in the radial direction are further split to two areas by a split line along the radial direction, respectively. That is to say, the second beam splitting unit 12′ in this case is split into four areas in total.

Here, in FIGS. 5A through 5C, a spot Sp of the reflected light from the optical disc 100 to be formed in the second beam splitting unit 12′ is represented, and also the superimposed area of ±1 order lights from the optical disc 100 in this spot Sp is represented with a screen, but the spilt line in the radial direction is set so that one of the two areas to be formed in the tangential direction by this split line becomes an area not overlapped with the superimposed area of ±1 order lights within such a spot Sp.

With regard to one area of the areas split into two in the radial direction, the area overlapped with the superimposed area of ±1 order lights formed by the split line is taken as “A” (diffraction area A), and the area not overlapped with this superimposed area is taken as “BB” (diffraction area BB). Also, with regard to another area of the areas split into two in the radial direction, the area overlapped with the superimposed area is taken as “AA” (diffraction area AA), and the area not overlapped with this superimposed area is taken as “B” (diffraction area B).

In the case of the present example, the diffraction areas B and BB not overlapped with the superimposed area are assumed to be formed in a position with vertical symmetry as illustrated in the drawing. Accompanied therewith, the diffraction areas A and AA are assumed to be formed in a position with vertical symmetry.

Based on the above premise, specific generating techniques of the lens error signal LE, push-pull signal PP, and focus error signal FE will be described.

First, the above-mentioned FIGS. 5A, 5B, and 5C illustrate the split beam patterns of the second beam splitting unit 12′, and also represent a scene of change in a position relation between the second beam splitting unit 12′ and the spot Sp due to lens shift of the objective lens 6.

Specifically, FIG. 5A illustrates a position relation between the spot Sp and the second beam splitting unit 12′ in the event that lens shift occurs in one direction of the tracking direction (radial direction), and FIG. 5C illustrates a position relation between the spot Sp and the second beam splitting unit 12′ in the event that lens shift occurs in the other direction of the tracking direction.

FIG. 5B illustrates a position relation between the spot Sp and the second beam splitting unit 12′ in an ideal state where no lens shift occurs.

Also, FIG. 5D illustrates a scene of the light flux of +1 order light and −1 order light to be output from the second beam splitting unit 12′ (cross-section in the tangential direction).

Also, FIG. 5E illustrates an example of a light-receiving element formation pattern on the second light-receiving unit 14.

In FIG. 5E, as light-receiving elements to be formed on the second light-receiving unit 14, there are formed two prominent units of a light-receiving unit for receiving +1 order light (generally named as +1 order side light-receiving unit D_p1) from the second beam splitting unit 12′ (each diffraction area), and a light-receiving unit for receiving −1 order light (generally named as −1 order side light-receiving unit D_m1).

In this case, as the +1 order side light-receiving unit D_p1, light-receiving elements D_p1Mll, D_p1Zll, D_p1Nll, D_p1Mir, D_p1Zir, D_p1Nlr, D_p1Mr, D_p1Zr, and D_p1Nr are formed as illustrated in the drawing.

Also, as the −1 order side light-receiving unit D_m1, light-receiving elements D_m1Ml, D_m1Zl, D_m1Nl, D_m1Mr, D_m1Zr, and D_m1Nr are formed as illustrated in the drawing.

Here, FIG. 5E illustrates a light-receiving spot of diffracted light from each diffraction area formed on the second beam splitting unit 12′.

A relation between each light-receiving element D and diffracted light to be received thereby is as follows. Note that “the upper portion” and “the lower portion” in the following are with FIGS. 5A through 5C illustrating the split beam patterns of the second beam splitting unit 12′ as references.

Also, with regard to −1 order side, from a relation serving as the near side focal point as illustrated in FIG. 5D, the reader has to pay attention to that the position relation of diffracted light is switched four directions with point symmetry with the optical axis as a reference.

### [+1 Order Light Side]

D_p1Mll . . . The upper portion of A

D_p1Zll . . . The lower portion of A

D_p1Nll . . . The lower side portion of A (small amount)

D_p1Mlr . . . The upper side portion of AA (small amount)

D_p1Zlr . . . The upper portion of AA

D_p1Nlr . . . The lower portion of AA

D_p1Mr . . . B

D_p1Zr . . . None

D_p1Nr . . . BB

### [−1 Order Light Side]

D_m1Ml . . . BB

D_m1Zl . . . None

D_m1Nl . . . B

D_m1Mr . . . The lower side portion of A (small amount) & the lower portion of AA

D_m1Zr . . . The lower portion of A & the upper portion of AA

D_m1Nr . . . The upper portion of A & the upper side portion of AA

Here, within the spot Sp, the superimposed area of ±1 order lights from the optical disc 100 described above becomes an area where a signal on which shift amount between a track formed on the optical disc 100 and the spot position is reflected is obtained. This means, in other words, that light on which components representing such shift amount as to a track are almost not reflected is input to the diffraction areas B and BB which have been set so as not to be overlapped with this superimposed area.

Accordingly, incident components to these diffraction areas B and BB can suitably be employed for detection of the lens error signal LE.

Now, it can be found with reference to FIG. 5B that in an ideal state in which there is no lens shift, input light amounts as to the diffraction areas B and BB not overlapped with the superimposed area of ±1 order lights from the optical disc 100 are generally equal.

On the other hand, in the event that lens shift in one direction illustrated in FIG. 5A occurs, in comparison with the ideal state illustrated in FIG. 5B, the amount of light to be input to the diffraction area BB becomes great, and the amount of light to the diffraction area B becomes small.

Also, in the event that lens shift in other direction illustrated in FIG. 5C occurs, conversely, the amount of light to be input to the diffraction area BB becomes small, and the amount of light to the diffraction area B becomes great.

Based on these points, with the present example, the lens error signal LE is assumed to be obtained by the following Expression 1. However, with the expressions indicated in the following Expressions, including this Expression 1, p1Mll, p1Zll, p1Nll, p1Mlr, p1Zlr, p1Nlr, p1Mr, p1Zr, p1Nr, m1Ml, m1Zl, m1Nl, m1Mr, m1Zr, m1Nr represent light-receiving signals according to the light-receiving elements D_p1Mll, D_p1Zll, D_p1Nll, D_p1Mlr, D_p1Zlr, D_p1Nlr, D_p1Mr, D_p1Zr, D_p1Nr, D_m1Ml, D_m1Zl, D_m1Nl, D_m1Mr, D_m1Zr, and D_m1Nr, respectively.

LE={(p1Mll+p1Mlr+p1Nr)−(p1Nll+p1Nlr+p1Mr)} Expression 1

Also, the push-pull signal PP is assumed to be obtained by the following Expression 2.

PP={(p1Mll+p1Zll+p1Nll+p1Nr)−(p1Mlr+p1Zlr+p1Nlr+p1Mr)} Expression 2

Also, the focus error signal FE is assumed to be obtained by the following Expression 3.

FE={(m1Ml+m1Mr+m1Nl+m1Nr+p1Zll+p1Zlr+p1Zr)−(m1Zl+m1Zr+p1Mll+p1Mlr+p1Mr+p1Nll+p1Nlr+p1Nr)} Expression 3

The focus error signal generating circuit 32 illustrated in the previous FIG. 2 generates following Expression 3, the lens error signal generating circuit 33 generates following Expression 1, and the push-pull signal generating circuit 34 generates following Expression 2 the focus error signal FE, lens error signal LE, and push-pull signal PP, respectively.

As described above, generation of the RF signal and DPD signal by split light reception using the first beam splitting unit 11′, and generation of the focus error signal FE (spot size method), lens error signal LE, and push-pull signal PP by split light reception using the second beam splitting unit 12′ are realized.

Note that, with regard to the lens error signal LE, calculation has to be performed assuming that the spot sizes of at least the diffraction areas B and BB are compared, and a calculation expression thereof is not restricted to Expression 1.

Also, though the lens error signal LE and push-pull signal PP have been generated using only the received light signal on the +1 order light side, it goes without saying that these may be generated using the received light signal on the −1 order light side (including a case using both of ±1 order lights).

Also, the focus error signal FE according to the spot size method has to be calculated assuming that the spot sizes to be expanded/reduced in the tangential direction are compared (see the previous FIGS. 4A through 4F), and a computation expression thereof is not restricted to Expression 3.

### 2. First Embodiment

### 2-1. Embodiment 1

Based on the above-mentioned premise, the embodiments according to the present technology will be described below.

First, as the first embodiment, description will be made regarding Embodiment on a first beam splitting unit side to be used for generation of the RF signal and DPD signal.

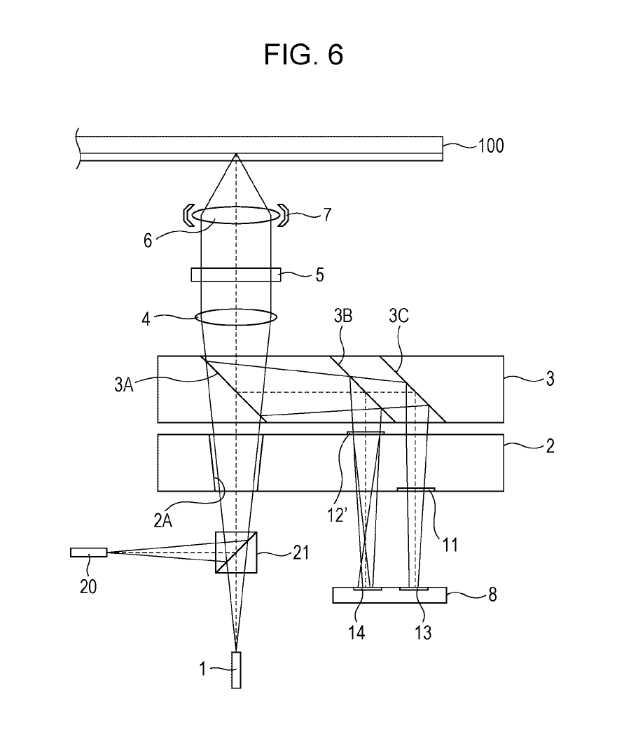

FIG. 6 is a diagram for describing the internal configuration of an optical disc device serving as Embodiment 1 of the first embodiment.

Note that, with the following description, the same portions as already described portions are denoted with the same reference numerals, and description thereof will be omitted.

Also, with the following description, a configuration to generate the RF signal and DPD signal (RF signal generating circuit 30 and DPD signal generating circuit 31) is the same as that illustrated in FIG. 2 unless otherwise noted, and accordingly, redundant description with reference to the drawings will be omitted.

The optical disc device serving as Embodiment 1 of the first embodiment differs from the optical disc device illustrated in the previous FIG. 1 in that an optical system for irradiating a laser beam conforming to the DVD standard (wavelength is 650 mm or so) is added, and also, with the compound lens 2, the first beam splitting unit 11 is provided instead of the first beam splitting unit 11′.

In this case, the laser 1 is assumed to emit a laser beam conforming to the BD standard (wavelength is 405 mm or so). Note that, in this sense, the laser 1 will be referred to as BD laser 1 below.

In FIG. 6, as a configuration to irradiate a laser beam for DVD, a DVD laser 20 and a dichroic prism 21 are provided.

As illustrated in the drawing, the dichroic prism 21 is disposed between the BD laser 1 and the compound lens 2, and outputs the laser beam emitted from the BD laser 1 (hereafter, also referred to as laser beam for BD), and the laser beam emitted from the DVD laser 20 (also referred to as laser beam for DVD) by matching the optical axes thereof using a wavelength selective surface thereof.

Specifically, the dichroic prism 21 in this case is configured to transmit light having the same wavelength band as with the laser beam for BD, and to reflect light according to a wavelength other than that, and outputs the laser beam for BD transmitting the wavelength selective surface, and the laser beam for DVD reflected at the wavelength selective surface so as to match the optical axes thereof.

The optical paths of irradiated light to the optical disc 100 and reflected light from the optical disc 100 in the case that a BD is mounted as the optical disc 100 and in response to this, the BD laser 1 is turned on are the same as described above in FIG. 1.

In the event that a DVD is mounted, and the DVD laser 20 is turned on, the laser beam for DVD from this DVD laser 20 is reflected at the dichroic prism 21, and then input to the compound lens 2 (the above-mentioned through hole 2A). The optical path of the laser beam for DVD after inputting to the compound lens 2 is the same as the case of the laser beam for BD, and accordingly, redundant description will be avoided.

Note that, in this case, the reflected light of the laser beam for BD and the reflected light of the laser beam for DVD are input to the second beam splitting unit 12′, but in the event that lights having different wavelengths are input to the second beam splitting unit 12′ serving as an HOE, the diffraction angles of these lights differ.

Therefore, with the second light-receiving unit 14 in this case, along with the light-receiving elements illustrated in the previous FIG. 5E for receiving the reflected light of the laser beam for BD, the same light-receiving elements as FIG. 5E for receiving the reflected light of the laser beam for DVD are separately formed.

Note that, with regard to the reflected light of the laser beam for DVD as well, when generating the lens error signal LE, focus error signal FE, and push-pull signal PP based on this, as for these computation expressions, the same expressions as the previous Expressions 1 through 3 may be employed, for example.

Now, with the optical disc device illustrated in FIG. 1, the beam splitting unit made up of a diffraction element serving as an HOE is provided as the first beam splitting unit 11′.

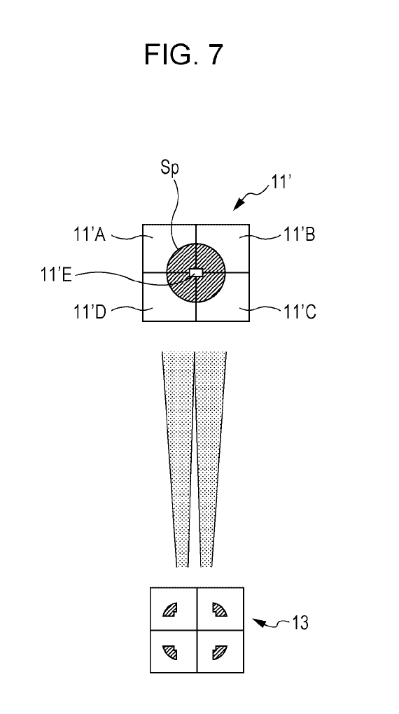

FIG. 7 is a diagram for describing a scene of split light reception in the case of employing the first beam splitting unit 11′ serving as an HOE. Note that, in FIG. 7, the spot of the reflected light from the optical disc 100 formed on the first beam splitting unit 11′ is referred to as Spot Sp.

As illustrated in FIG. 7, with the first beam splitting unit 11′ according to the related art, four diffraction areas of diffraction areas 11′A, 11′B, 11′C, and 11′D are formed. Specifically, split light reception for generating the RF signal and DPD signal is enabled by splitting the reflected light beam from the optical disc device into four directions using these four diffraction areas.

Now, with the first beam splitting unit 11′ in this case, there is formed in the center portion thereof a diffraction area 11′E (mask diffraction area) for scattering the light of the center portion of the reflected light beam from the optical disc device to a location other than the first light-receiving unit 13 by diffraction.

Such a diffraction area 11′ in the center portion is provided to suppress deterioration in C/N caused by stray light (reflected light from a recording layer nearer than a recording layer to be recorded or played) which occurs in the event of a disc having multiple recording layers being mounted as the optical disc 100 being received.

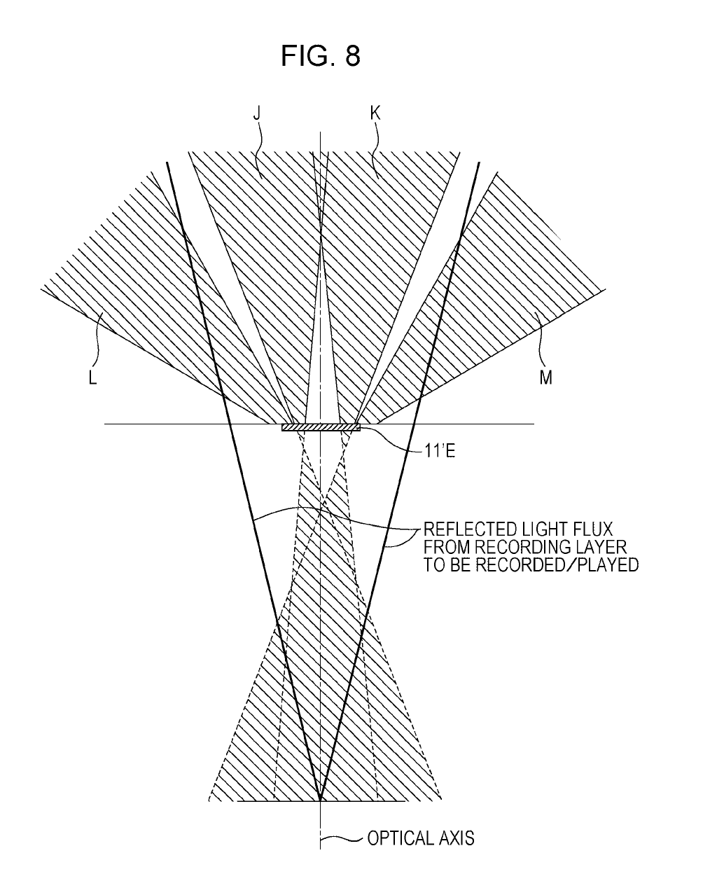

FIG. 8 is a diagram for describing operation by a mask diffraction area being disposed in the light flux center portion in the light of stray light removal.

First, as a premise, the formation positions of a recording layer to be recorded/played and another recording layer serving as the source origin of stray light differ, and accordingly, difference in focal positions occurs between the reflected light from the recording layer to be processed and stray light. Specifically, the focal position of stray light is near a position where the first beam splitting unit 11′ is disposed.

The reason why the light flux center portion is taken as the formation position of the mask diffraction area 11′E is in the light of a situation wherein at near the face where the first beam splitting unit 11′ is disposed the received light amount of stray light (J and K in the drawing) to be input with a relatively shallow angle is greater than the received light amount of stray light (L and M in the drawing) to be input with a relatively deep angle.

When the mask diffraction area 11′E is disposed in the light flux center portion, as illustrated in the drawing, a portion other than the center portion can be suitably be received regarding the reflected light from the recording layer to be processed while removing stray light to be input with a relatively shallow angle causing increase in the received light amount. That is to say, the reflected light from the recording layer to be processed can also be received while selectively removing stray light causing great influence on deterioration in C/N.

Now, in the event that a beam splitting unit according to an HOE serving as the first beam splitting unit 11′ is provided, particularly when employing a configuration compatible with multiple waveforms as illustrated in FIG. 6, the following problem occurs.

Specifically, with regard to diffraction at the HOE, the same diffraction angle and same diffraction efficiency are not realized for wavelength dependency thereof, and as a result thereof, it is substantially difficult to match the split beam directions regarding lights having different wavelengths. Therefore, the lights having different wavelengths are not received using a shared detector, so a separate light-receiving unit has to be formed for each wavelength.

As a result thereof, a problem occurs such as leading to increase in costs due to increase in the number of parts, difficulty in reduction in size, or the like.

There is also a problem in that blazed holograms used as HOE are relatively low in efficiency (i.e., the loss of light is relatively great), and contributes to deterioration in C/N correspondingly.

The first embodiment has been made in the light of such problems to enable a common light-receiving unit to be used for receiving multiple-wavelength lights, and also to improve C/N by reducing the loss of light due to beam splitting using a configuration wherein easing of position precision requested for suitable split light reception is realized by performing beam splitting in front of the light-receiving surface.

With the optical disc device according to the first embodiment, there is provided a beam splitting unit which performs beam splitting using refraction instead of diffraction.

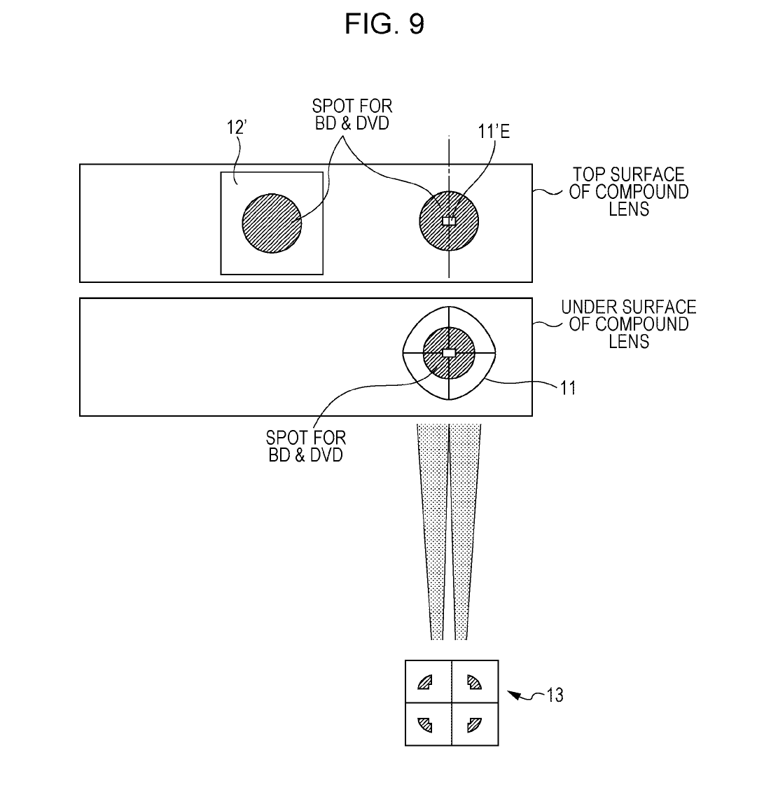

FIG. 9 is a diagram for describing the first beam splitting unit 11 included in the optical disc device serving as Embodiment 1 of the first embodiment.

Note that FIG. 9 also illustrates a scene of split light reception using this first beam splitting unit 11 along with the configuration of the first beam splitting unit 11.

First, in this case, the first beam splitting unit 11 is formed on the lower face side of the compound lens 2, i.e., the surface on the side facing the first light-receiving unit 13 (light-receiving surface).

In this case, the mask diffraction area 11′E (hereafter, referred to as diffraction element 11′E) is formed on the upper face side of the compound lens 2 (the surface on the opposite side of the lower face: the surface on the side facing the laminated prism 3). That is to say, this is to perform removal of stray light.

The spots of the reflected light of a laser beam for BD and the reflected light of a laser beam for DVD are formed on the upper face side of the compound lens 2. Specifically, the spot of the reflected light of a laser beam for BD is formed at the time of lighting of the BD laser 1, and the spot of the reflected light of a laser beam for DVD is formed at the time of lighting of the DVD laser 20.

As can be understood with reference to FIG. 6, the spots of these BD and DVD are formed in two sets on the upper face side of the compound lens 2. Specifically, one set is the spots of a BD and DVD regarding light reflected at a total reflection face 3C in the laminated prism 3 and input to the compound lens 2, and the other set is the spots of a BD and DVD regarding light reflected at a half-reflection face 3B in the laminated prism 3 and input to the compound lens 2.

The diffraction element 11′E is, with the upper face side of the compound lens 2, formed in positions where the reflected lights of BD and DVD laser beams reflected at the total reflection face 3C are input as described above. Specifically, the diffraction element 11′E is formed in a position near the center positions of the spots regarding the reflected lights of BD and DVD laser beams reflected at the total reflection face 3C.

Also, the second beam splitting unit 12′ is, with the upper face side of the compound lens 2, formed in positions where the reflected lights of BD and DVD laser beams reflected at the half-reflection face 3B are input as described above.

Note that, as can be understood from the description so far, a laser beam for BD and a laser beam for DVD are arranged so that the optical axes thereof match, and accordingly, as a set of the spots formed on the upper face side of the compound lens 2 as described above, the center positions thereof (optical axial positions) are also the same.

The first beam splitting unit 11 is formed, with the lower face side of the compound lens 2, so that the center position thereof agrees with the optical axes of the reflected lights of BD and DVD laser beams reflected at the total reflection face 3C.

Note that, with the lower face side of the compound lens 2, the reason why the spot center portions of the reflected lights of BD and DVD laser beams are illustrated with a notch is to represent that the light of the light flux center portion is removed by the diffraction element 11′E.

As illustrated in the drawing, the first beam splitting unit 11 has four split beam areas and is configured so as to split incident light into four directions. That is to say, the first beam splitting unit 11 is configured to have four split beam areas so as to enable four-split light reception for generating the RF signal and DPD signal using a common light-receiving element.

The first beam splitting unit 11 in this case is split into four by a cross split line, and the intersection (the center of the cross) of this cross split line is arranged to generally agree with the optical axes of the reflected lights of BD and DVD laser beams.

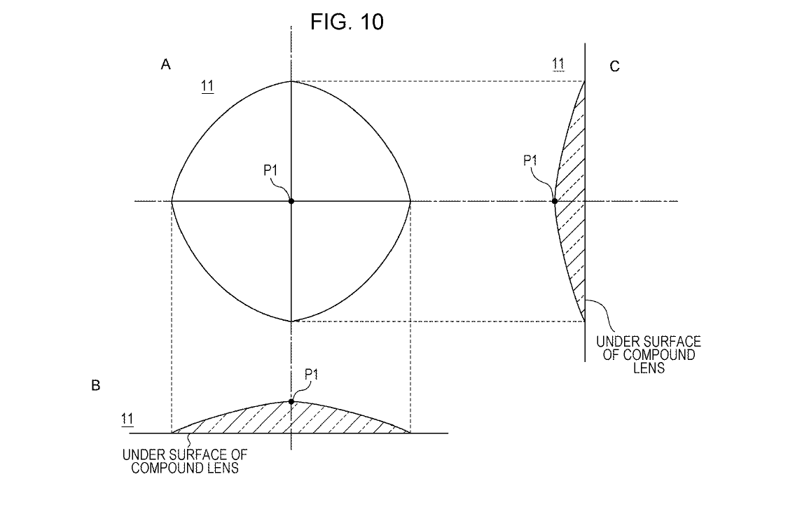

FIG. 10 is a diagram illustrating a specific configuration example of the first beam splitting unit 11 included in the optical disc device serving as Embodiment 1 of the first embodiment.

In A through C in FIG. 10, A in FIG. 10 illustrates a plan view of the first beam splitting unit 11, B in FIG. 10 illustrates a horizontal cross-sectional view of the first beam splitting unit 11, and C in FIG. 10 illustrates a vertical cross-sectional view of the first beam splitting unit 11, respectively.

The split beam areas of the first beam splitting unit 11 are configured so as to refract and output incident light.

In this case, any one of the incident face and output face of each beam split area has a spherical shape. Specifically, with the present example, the incident face side of each beam split area has a spherical shape, and the output face side has a planar shape. The reason why at least any one of the incident face and output face of each beam split area has a spherical shape is to take optical distance up to each light-receiving element formed on the first light-receiving unit 13 into consideration and to adjust focal point distance as appropriate.

As described above, an intersection (agrees with the center of the first beam splitting unit 11 in this case) P1 of a cross split line of the first beam splitting unit 11 is arranged to agree with the optical axes of the reflected lights of BD and DVD laser beams.

Therefore, incident light is split into four directions with the cross split line as a boundary.

Note that, in FIG. 10, the first beam splitting unit 11 has a shape simply combined with four spherical surfaces, and accordingly, the entire outer shape is a complicated shape with four circular arcs being combined.

However, in the event of having such a complicated outer shape, in general, metal mold manufacturing slightly becomes difficult.

In order to further facilitate metal mold manufacturing, it is desirable to have a simple outer shape such as a circular shape, elliptical shape, or track shape.

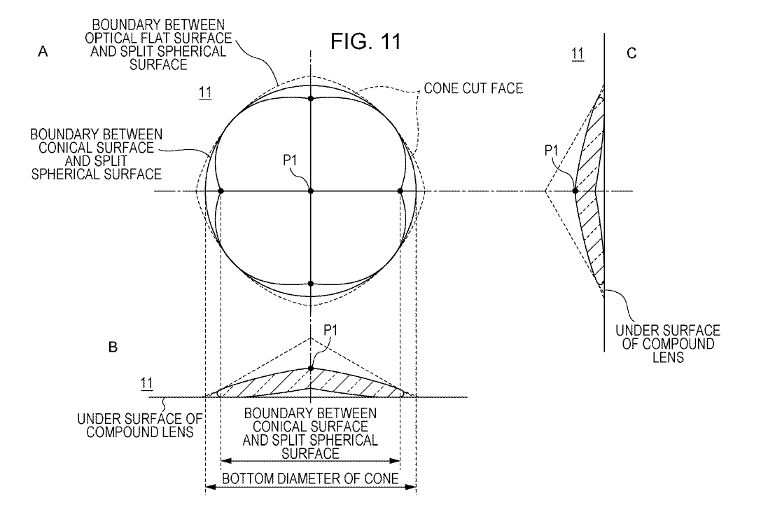

FIG. 11 is a diagram illustrating a shape example of the first beam splitting unit 11 to further facilitate metal mold manufacturing. In the same way as with the previous FIG. 10, A in FIG. 11 illustrates a plan view, B in FIG. 11 illustrates a horizontal cross-sectional view, and C in FIG. 11 illustrates a vertical cross-sectional view.

As illustrated in A through C in FIG. 11, the outer shape of a metal mold can have a circular shape by combining a split spherical surface and a conic surface. Specifically, in this case, the outer shape of a metal mold is configured wherein a split spherical shape is disposed within a cone, whereby a conic metal mold can be used as a metal mold for molding the first beam splitting unit 11.

Manufacturing and embedding of a metal mold coma can be facilitated, whereby this configuration contributes to improvement in molding accuracy and reduction in costs.

As described above, with the first embodiment, beam splitting is performed by refraction instead of diffraction, whereby rays having different wavelengths can be split in the same direction. As a result thereof, rays having different wavelengths such as a BD or DVD or the like can be received using a common light-receiving element, for example.

Light-receiving elements different for each wavelength do not have to be provided, whereby simplification in configuration and reduction in costs can be realized.

Also, beam splitting by refraction is employed, whereby efficiency can be improved as compared to employing blazed holograms such as an HOE or the like, and deterioration in C/N (carrier-to-noise ratio) due to beam splitting can be suppressed.

Also, the same function can be realized with cutting alone without using electron beam lithography for metal mold manufacturing such as blazed holograms, and accordingly, metal mold costs can be suppressed low.

Also, there are no fine irregularities like blazed holograms, and accordingly, surface coating such as AR (Anti Reflection) coating or the like can readily be performed, and coating can be performed in a more stable and easy manner.

Also, there are no fine irregularities like blazed holograms, and accordingly, light resistance can also readily be secured. In other words, performance deterioration due to light can be prevented from readily occurring.

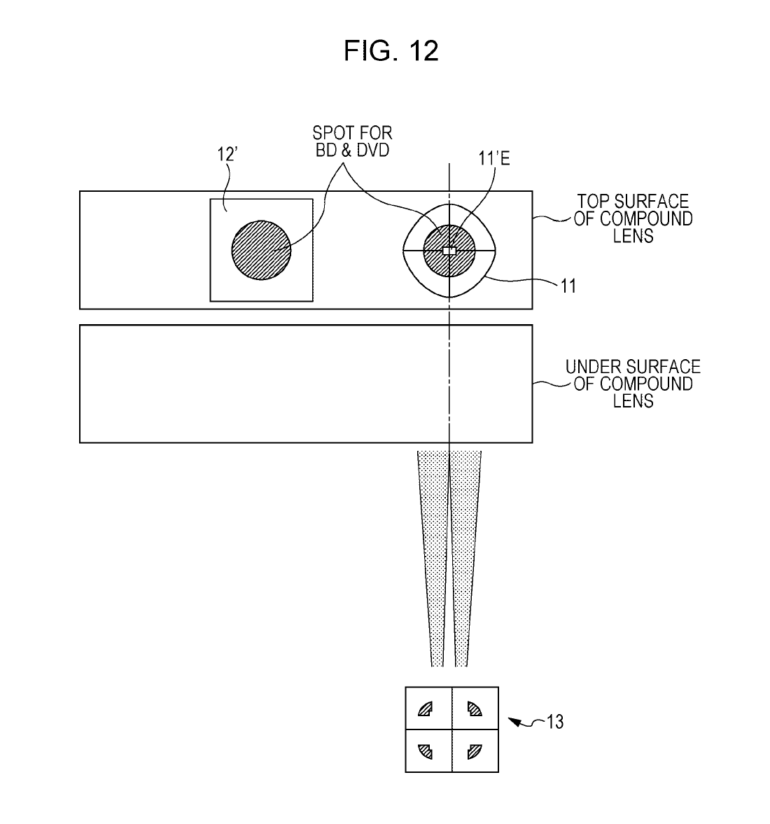

FIG. 12 is a diagram for describing a modification regarding Embodiment 1 of the first embodiment.

As illustrated in FIG. 12, the first beam splitting unit 11 can be formed along with the diffraction element 11′E as to the upper face side of the compound lens 2.

In respect of manufacturing of a metal mold, though slightly complicated as compared to FIG. 9, both can be formed on one side of a mold part serving as the compound lens 2, and accordingly, position adjustment for the mold part can readily be performed.

Note that, with the first embodiment, in the event that there are no circumstances wherein stray light has to be removed, such as, in order to handle single-layer discs alone as the optical disc 100, for example, it goes without saying that the diffraction element 11′E for stray light removal can be omitted. In the event of omitting the diffraction element 11′E, manufacturing of the compound lens 2 can readily be performed, and also the amount of received light can be increased by reducing loss of light.

### 2-2. Embodiment 2

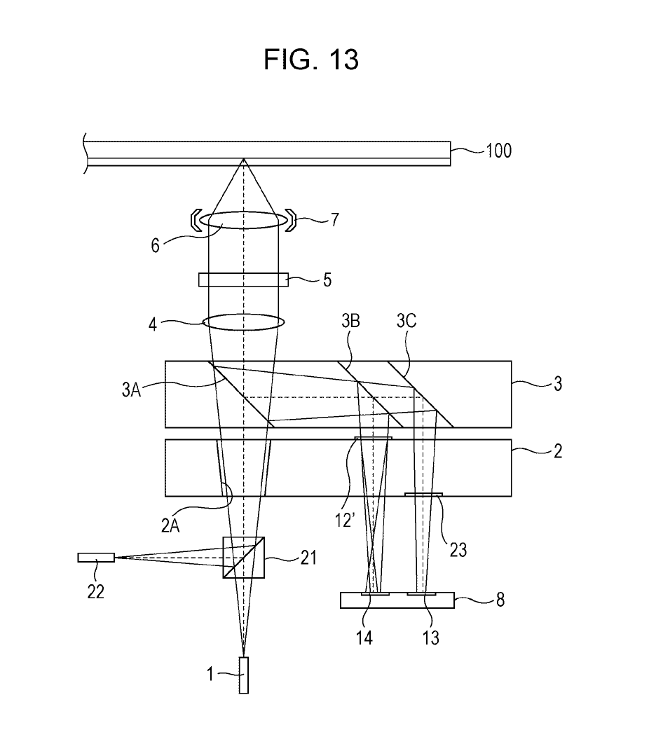

FIG. 13 is a diagram for describing the internal configuration of an optical disc device serving as Embodiment 2 of the first embodiment.

An optical disc device compatible with not only BD and DVD but also CD, i.e., a so-called three-wavelength compatible optical disc device is taken as the optical disc device serving as this Embodiment 2.

Specifically, the optical disc device in this case differs from the optical disc device (FIG. 6) according to the previous Embodiment 1 in that a DVD and CD laser 22 is provided instead of the DVD laser 20, and also a first beam splitting unit 23 is provided instead of the first beam splitting unit 11.

The DVD and CD laser 22 is configured so as to selectively emit a laser beam for DVD and a laser beam for CD (wavelength=780 nm or so).

With this DVD and CD laser 22, the luminous point of a laser beam for DVD and the luminous point of a laser beam for CD are positioned in different positions, and the optical axes of a laser beam for DVD and a laser beam for CD do not agree. With the optical pickup according to the present example, in the same way as with the case of the previous Embodiment 1, let us say that the laser luminous points have been adjusted so that the optical axis of a laser beam for DVD and the optical axis of a laser beam for BD agree.

Note that the optical path of the laser beam for DVD emitted from the DVD and CD laser 22 is the same as with the case of Embodiment 1, and accordingly, description thereof will be omitted.

The laser beam for CD emitted from the DVD and CD laser 22 is reflected at the dichroic prism 21, and is, in a state in which the optical axis thereof deviates from the optical axes of the laser beam for BD and laser beam for DVD, irradiated on the optical disc 100 via the compound lens 2 (through hole 2A)→laminated prism 3 (polarization selective reflection face 3A)→collimating lens 4→quarter-wave plate 5→objective lens 7.

With the return trip as well, the reflected light of the laser beam for CD is, in a state in which the optical axis thereof deviates from the reflected lights of the laser beam for BD and laser beam for DVD, guided to the half-reflection film 3B and total reflection film 3C via the objective lens 7→quarter-wave plate 5→collimating lens 4→laminated prism 3 (polarization selective reflection face 3A).

The reflected light of the laser beam for CD reflected at the half-reflection film 3B is input to the second beam splitting unit 12′ in a state in which an optical axis thereof is inclined as to the optical axis of the reflected light of the laser beam for BD reflected at this half-reflection film 3B, and split at this second beam splitting unit 12′, and received by the second light-receiving unit 14.

Note that, in this case, in order to also receive reflected light regarding CD along with BD and DVD, a light-receiving element for receiving the reflected light of CD is separately provided to the second light-receiving unit 14.

The reflected light of the laser beam for CD reflected at the total reflection film 3C is input to the first beam splitting unit 23 in a state in which an optical axis thereof is inclined as to the optical axis of the reflected light of the laser beam for BD reflected at this total reflection film 3C, and split at this first beam splitting unit 23, and received by the first light-receiving unit 13.

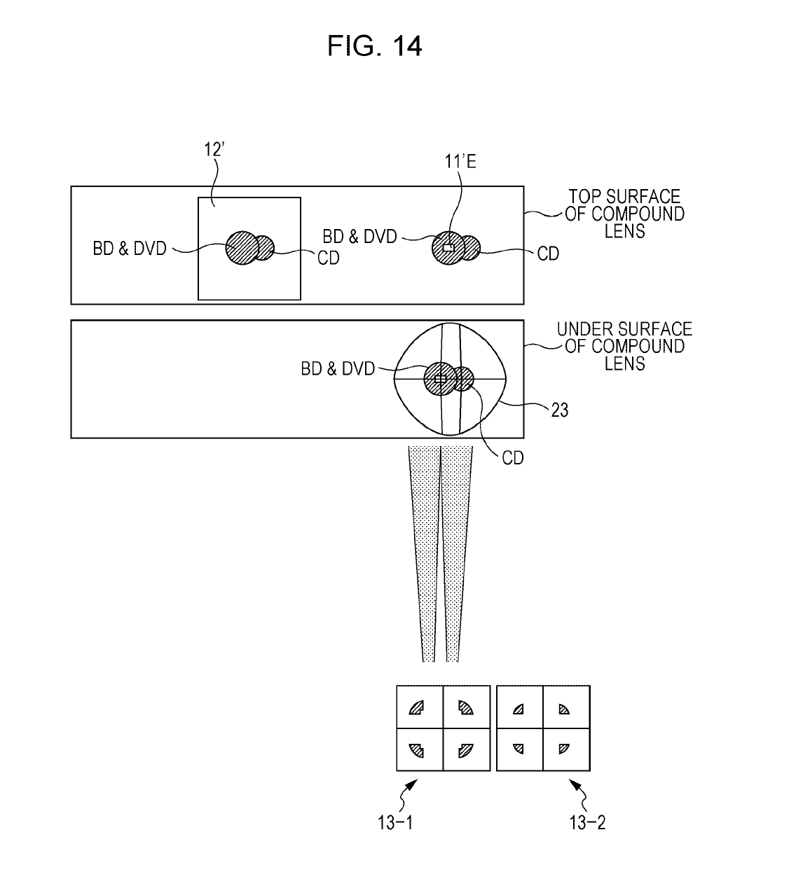

FIG. 14 is a diagram for describing the first beam splitting unit 23 included in the optical disc device serving as Embodiment 2 of the first embodiment.

As illustrated in this FIG. 14, the first beam splitting unit 23 in this case is also formed on the lower side of the compound lens 2.

Also, in this case, the diffraction element 11′E for mask is formed on the upper face side of the compound lens 2 along with the second beam splitting unit 12′.

Now, with Embodiment 2, the reflected light for CD is obliquely input to the upper face of the compound lens 2 due to that the luminance points for DVD and CD differ at the DVD and CD laser 22, and also the optical axis for DVD agrees with the optical axis for BD. As a result thereof, position shift occurs between the spots for BD and DVD and the spot for CD formed on the upper face and lower face of the compound lens 2.

In this case, the diffraction element 11′E is disposed in a position near the optical axes of the reflected lights for BD and DVD (i.e., positioned in the light flux center portions of the reflected lights for BD and DVD). That is to say, there is no disc having multiple recoding layers conforming to the above standard regarding CD, and accordingly, the diffraction element 11′E for stray light removal has to be provided in positions where the reflected lights for BD and DVD are input as described above.

In this case, the previous first beam splitting unit 11 to which a cross split line for CD has further been added is employed as the second beam splitting unit 23 so as to perform, regarding the reflected light for CD input to a position different from the BD and DVD side by oblique incidence as well, suitable four splitting with an optical axis thereof as a reference. Specifically, the cross split line is added in this way, and accordingly, the second beam splitting unit 23 has six beam split areas in total by a set of three consecutive beam split areas being adjacently disposed in two rows as illustrated in the drawing.

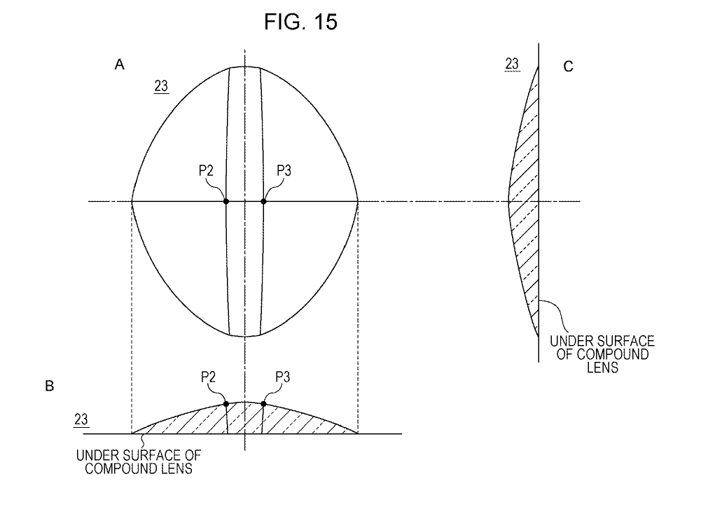

FIG. 15 is a diagram illustrating a specific configuration example of the first beam splitting unit 23 included in the optical disc device serving as Embodiment 2 of the first embodiment.

In the same way as with the previous FIG. 10, A in FIG. 15 illustrates a plan view, B in FIG. 15 illustrates a horizontal cross-sectional view, and C in FIG. 15 illustrates a vertical cross-sectional view.

First, as described above, the two cross split lines are formed in the first beam splitting unit 23. In the drawing, intersections of these cross split lines are indicated as intersections P2 and P3, respectively.

Each of six beam split areas sectioned by these two cross split lines is configured so as to refract and output incident light.

Note that, in this case as well, any one of the incident face and output face of each beam split area has a spherical shape (incident face side in the example in this drawing). That is to say, optical distance up to each light-receiving element formed on the first light-receiving unit 13 is taken into consideration, and focal point distance adjustment is performed as appropriate.

In this case, the intersection P2 of the first beam splitting unit 23 agrees with the optical axes of the reflected lights for BD and DVD, and the intersection P3 agrees with the optical axis of the reflected light for CD. Thus, the reflected lights for BD and DVD are split into four directions with the cross split line having the intersection P2 as a boundary, and also the reflected light for CD is split into four directions with the cross split line having the intersection P3 as a boundary.

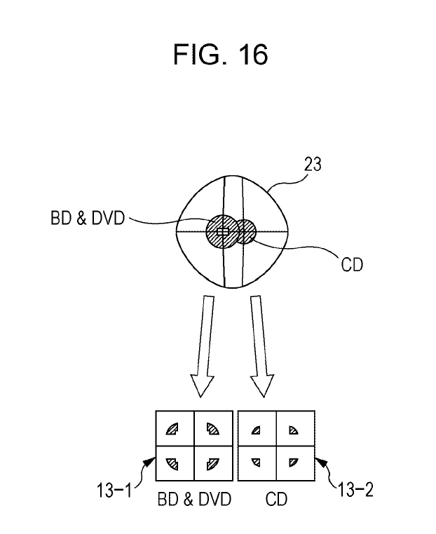

FIG. 16 is a diagram illustrating a correspondence relation between the light-receiving element formed on the first light-receiving unit 13 included in the optical disc device serving as Embodiment 2 of the first embodiment and the light-receiving spots of the reflected lights for BD and DVD and the reflected light for CD.

As described above, according to the first beam splitting unit 23 in this case, the reflected lights for BD and DVD, and the reflected light for CD are split into four directions, respectively.

With the first light-receiving unit 13 in this case, there are provided multiple light-receiving elements for receiving the lights of the reflected lights for BD and DVD, and the reflected light for CD, thus split. Specifically, in this case, the reflected lights are spilt into four directions, and accordingly, there are formed a light-receiving unit 13-1 serving as a four-split detector for BD and DVD, and a light-receiving unit 13-2 serving as a four-split detector for CD.

As illustrated in the drawing, each light regarding the reflected lights for BD and DVD split at the first beam splitting unit 23 is received by the corresponding light-receiving element of four light-receiving elements formed on the light-receiving unit 13-1. Also, each light regarding the reflected light of CD split at the first beam splitting unit 23 is received by the corresponding light-receiving element of four light-receiving elements formed on the light-receiving unit 13-2.

With Embodiment 2 as well, beam splitting is performed by refraction instead of diffraction, whereby the same advantage as with the previous Embodiment 1 can be obtained.

On that basis, according to this Embodiment 2, with a configuration compatible with three waveforms of BD, DVD, and CD, in response to a case where one type of laser beam thereof is obliquely input, suitable split light reception regarding the laser light to be obliquely input can be realized.

Note that, with Embodiment 2 described above as well, in the same way as with the first beam splitting unit 11 illustrated in the previous FIG. 10, the first beam splitting unit 23 has a shape simply combined of six spherical surfaces, and accordingly, the entire outer shape thereof becomes a complicated shape combined of six circular arcs, and accordingly, metal mold manufacturing may be difficult.

In this case as well, in order to further facilitate metal mold manufacturing, it is desirable to have a simple outer shape such as a circular shape, elliptical shape, or track shape.

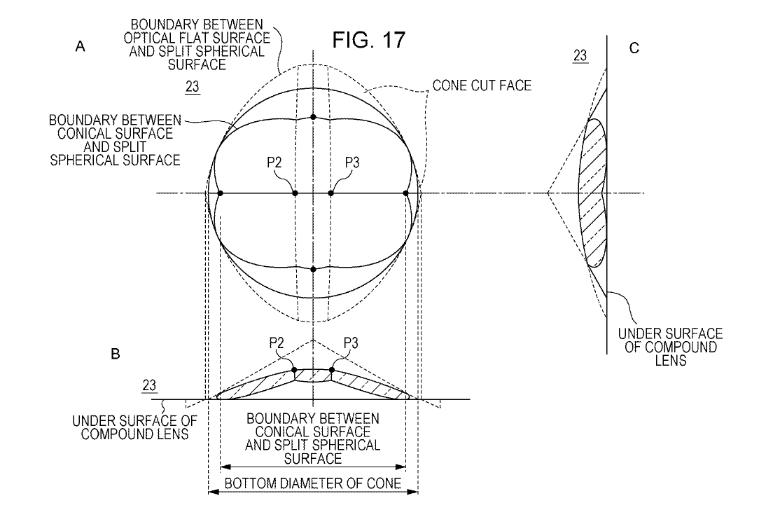

FIG. 17 is a diagram illustrating a shape example of the first beam splitting unit 23 to further facilitate metal mold manufacturing. In the same way as with the previous FIG. 10, A in FIG. 17 illustrates a plan view, B in FIG. 17 illustrates a horizontal cross-sectional view, and C in FIG. 17 illustrates a vertical cross-sectional view.

As illustrated in A through C in FIG. 17, the outer shape of a metal mold can have a circular shape by combining a split spherical surface and a conic surface. Specifically, in this case as well, the outer shape of a metal mold is configured wherein a split spherical shape is disposed within a cone, whereby a conic metal mold can be used as a metal mold for molding the first beam splitting unit 23.

Manufacturing and embedding of a metal mold coma can be facilitated, whereby this configuration contributes to improvement in molding accuracy and reduction in costs.

Incidentally, with Embodiment 1 and Embodiment 2 described so far, though it has been taken as a premise to generate the RF signal and DPD signal alone by split light reception using the first beam splitting unit (11 or 23), according to split light reception using the first beam splitting unit, a signal other than the DPD signal, e.g., such as a tracking error signal according to a DPP (Differential Push-Pull) method can also be generated along with the RF signal.

For example, in the event of generating a tracking error signal according to the DPP method, a laser beam to be irradiated on the optical disc 100 is split into three beams. That is to say, the reflected lights regarding these three beams are individually received to perform generation of a signal.

In the event of performing irradiation and reception regarding such three beams, the optical axis of each beam has to be disposed on the cross spilt line in the first beam splitting unit.

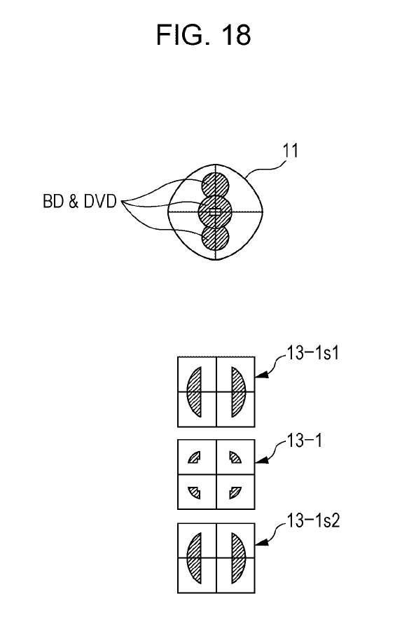

FIG. 18 is a diagram illustrating a relation between the first beam splitting unit (11 or 23) when employing three beams in the case of Embodiment 1 and the spot position of each beam, and a relation between each light-receiving element to be formed on the first light-receiving unit 13 and the spot position of each beam.

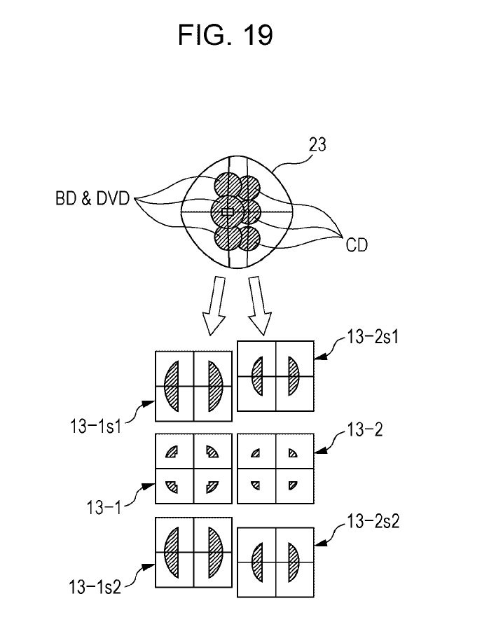

FIG. 19 is a diagram illustrating a relation between the first beam splitting unit (11 or 23) when employing three beams in the case of Embodiment 2 and the spot position of each beam, and a relation between each light-receiving element to be formed on the first light-receiving unit 13 and the spot position of each beam.

As illustrated in FIG. 18, in the case of Embodiment 1, the optical axis of each beam has to be disposed on the cross split line of the first beam splitting unit.

Thus, suitable four splitting can be performed regarding a main beam to be disposed in the center, and also suitable two splitting can be performed regarding the side beams.

Note that, in FIG. 18, with the first light-receiving unit 13 in this case, along with the light-receiving unit 13-1 for receiving the reflected light of the main beam, there are formed a light-receiving unit 13-1s1 for receiving the reflected light of one of the side beams, and a light-receiving unit 13-1s2 for receiving the reflected light of the other side beam. The example in this drawing exemplifies a case where these three light-receiving units 13-1 are all configured of four-split detectors.

Also, in the case of Embodiment 2 illustrated in FIG. 19, with regard to three beams for BD and DVD, the optical axes of the beams are arranged to agree on the split line of the tangential direction (i.e., the array direction of a beam) of a cross split line including an intersection P2 of two cross split lines formed on the first light-receiving unit 23.

With regard to three beams for CD, the optical axes of the beams are arranged to agree on a split line of the tangential direction of a cross split line having an intersection P3.

Thus, with regard to both of BD and DVD, and CD, suitable four splitting can be performed regarding the main beam, and also suitable two splitting can be performed regarding the side beams.

In the case of Embodiment 2, with the first light-receiving unit 13, as illustrated in the drawing, with regard to three beams for BD and DVD, there are provided the light-receiving units 13-1, 13-1s1, and 13-1s2, and with regard to three beams for CD, there are provided along with the light-receiving unit 13-2 for receiving the reflected light of the main beam, a light receiving unit 13-2s1 for receiving the reflected light of one of the side beams, and a light-receiving unit 13-2s2 for receiving the reflected light of the other side beam.

Note that the example in this drawing exemplifies a case where the three light-receiving units 13-2 for CD are all configured of four-split detectors.

Note that generation of three beams can be realized by splitting a laser beam emitted from a light source using a beam splitting element such as grating or the like, for example.

### 3. Second Embodiment

### 3-1. Mask Diffraction Area According to Related Art and Problem Thereof

Next, the second embodiment will be described.

The second embodiment relates to a second beam splitting unit formed on the compound lens 2.

Now, as described above, with a configuration wherein a beam splitting unit is disposed in front of the light-receiving surface to perform split light reception for realizing easing of position precision, in order to handle the optical disc 100 having multiple recording layers, a mask diffraction area to remove stray light has been provided to this beam splitting unit.

With not only the RS signal generating side alone described above but also the second beam splitting unit 12′ side which is a side where the focus error signal FE according to the spot size method, and the lens error signal LE are generated, such a mask diffraction area to remove stray light is provided. Specifically, with the second beam splitting unit 12′ side, it turns out that particularly, the quality of the lens error signal LE is deteriorated as influence due to stray light of a multi-layer disc, and as measures thereof a mask diffraction area is provided.

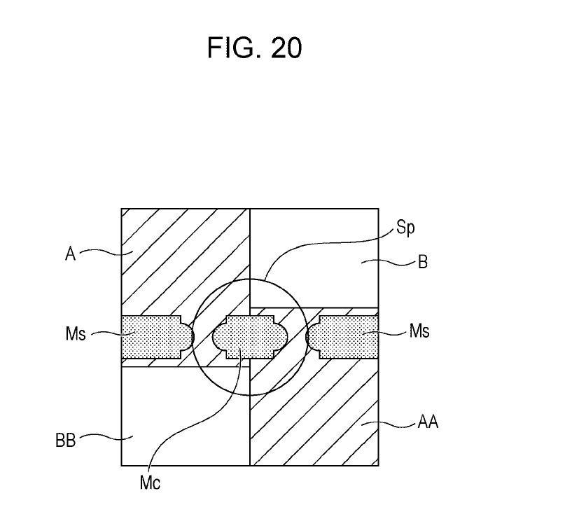

FIG. 20 illustrates a configuration example of the second beam splitting unit 12′ where a mask diffraction area for removing stray light compatible with the case of a two-layer disc is formed.

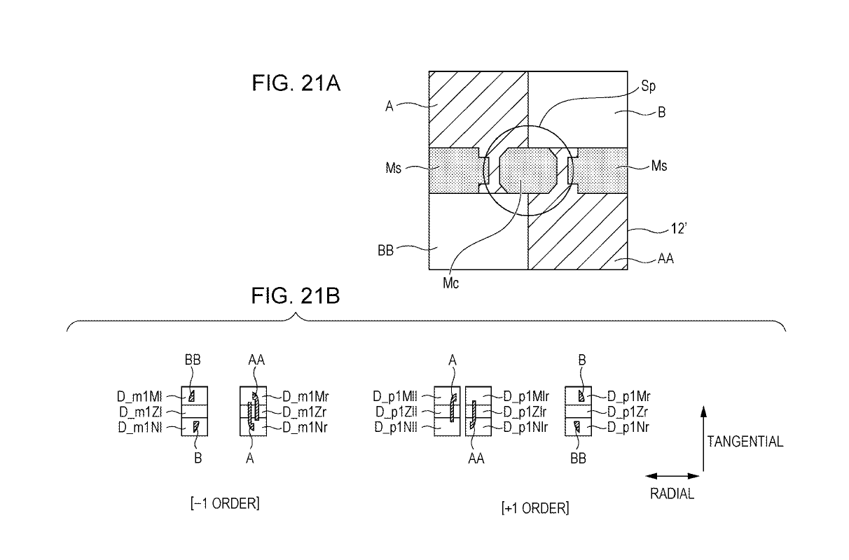

Also, FIGS. 21A and 21B are diagrams for describing a configuration example of the second beam splitting unit 12′ where there is formed a mask diffraction area for performing stray light removal compatible with a case of a multi-layer disc having three or more recording layers (this diagram illustrates an example of being compatible with a four-layer disc).

Of FIGS. 21A and 21B, FIG. 21A illustrates a configuration example of the second beam splitting unit 12′ where a mask diffraction area compatible with a multi-layer disc is formed, and FIG. 21B illustrates a position relation between each of the light-receiving elements formed in the second light-receiving unit 14 and the light-receiving spot of each light split by the second beam splitting unit 12′ where the mask diffraction area is formed.

When comparing FIGS. 20 and 21, it can be found that measures for expanding the mask diffraction area are taken with multi-layering of the optical disc 100. In particular, of a diffraction area Ms formed partially overlapped with the light flux outer edge portion, and a diffraction area Mc positioned in the light flux center portion, the diffraction area Mc side of the center portion is expanded, thereby suitably removing stray light which increases with increase in the number of recording layers.

However, in the event of expanding the mask diffraction area Mc as described above as measures for a multi-layer disc, this causes a problem in that deterioration in the quality of the lens error signal LE can be suppressed, but on the other hand, the quality of the focus error signal FE is deteriorated.

This means, that is to say, that the components of the light flux center portion have to be removed for generating the suitable lens error signal LE, but are, on the other hand, important for generating the focus error signal FE according to the spot size method.

Here, specifically, deterioration in the focus error signal FE emerges as distortion of the waveform of the S-letter signal.

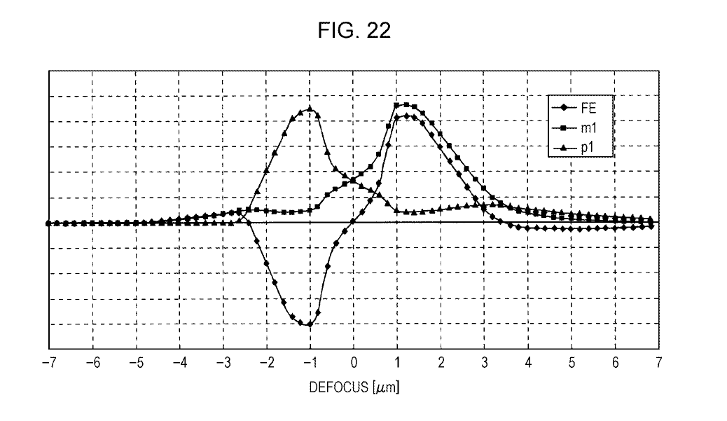

FIG. 22 is a diagram for describing distortion of the focus error signal FE (S-letter signal) in the event of providing a mask diffraction area compatible with a multi-layer disc illustrated in FIGS. 21A and 21B. Specifically, FIG. 22 illustrates the waveforms of the focus error signal FE, m1 signal, and p1 signal which are obtained at the time of performing focus search operation.

Here, “m1 signal” is a signal equivalent to summation of received light signals regarding −1 order light by the second beam splitting unit 12′, and “p1 signal” is a signal equivalent to summation of received light signals at each +1 order light by the second beam splitting unit 12′.

Specifically, in the event of performing generation of the focus error signal FE by the previous Expression 3, this is equivalent to the following.

m1=m1Ml+m1Mr+m1Nl+m1Nr+p1Zll+p1Zlr+p1Zr p1=m1Zl+m1Zr+p1Mll+p1Mlr+p1Mr+p1Nll+p1Nlr+p1Nr

Note that, according to Expression 3, it can be found that the focus error signal FE is a calculation result of difference between the m1 signal and p1 signal.

As can be understood from FIG. 22, in the event of realizing expansion of the mask diffraction area, distortion of the waveform of an intermediate section (between positive/negative peaks) of the S-letter signal occurs.

As a result of distortion of such an S-letter waveform occurring, it becomes difficult to perform focus-on operation as to a desired recording layer in a stable manner. Also, this simultaneously leads to deterioration in servo properties.

The second embodiment has been made in the light of such a problem, and is for realizing suppression of quality deterioration of the lens error signal due to stray light regarding a multi-layer disc, and also for realizing suppression of quality deterioration of the focus error signal (S-letter signal) at the same time using a configuration wherein the reflected light from the optical disc is split and received by a diffraction element to perform detection of the focus error signal according to the spot size method and the lens error signal from the received signal thereof.

### 3-2. Embodiment 1

With the second embodiment, in order to solve the above-mentioned problem, there is employed a technique wherein the light of a portion of the mask diffraction area Mc that the second beam splitting unit 12′ according to the related art has is received by a light-receiving element newly provided to the second light-receiving unit 14, and calculation of the focus error signal FE is performed using a received signal thereof.

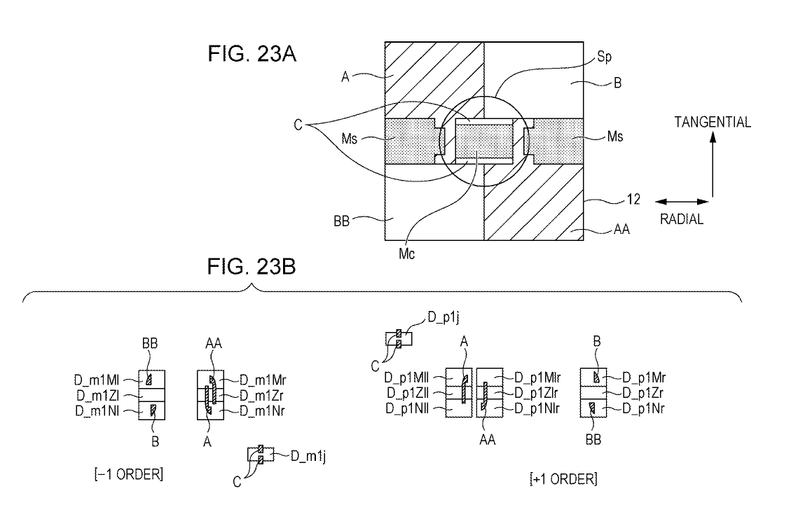

FIGS. 23A and 23B are diagrams for describing a focus error signal FE generating technique serving as Embodiment 1 of the second embodiment.

Specifically, FIG. 23A illustrates a diffraction area formation pattern of the second beam splitting unit 12 included in the optical disc device serving as Embodiment 1 of the second embodiment, and FIG. 23B illustrates a position relation between each of the light-receiving elements formed on the second light-receiving unit 14 and the light-receiving spot of diffracted light by the second beam splitting unit 12.

Note that, with this Embodiment 1, the internal configurations of the optical disc device are the same as those in FIGS. 1 and 2 except that the second beam splitting unit 12 is provided instead of the second beam splitting unit 12′, a light-receiving element which the second light-receiving unit 14 includes is that illustrated in FIG. 23B, and signal calculation by the focus error signal generating circuit 32 differs, and accordingly redundant description will be omitted.

As illustrated in FIG. 23A, with the second beam splitting unit 12, there are formed a mask diffraction area Mc for removing light of the light flux center portion, a diffraction area C formed adjacent to the outer edge of this mask diffraction area Mc, and a diffraction area A, diffraction area B, diffraction area AA, and diffraction area BB serving as diffraction areas formed adjacent to the outer edge of this diffraction area C.

As can be understood from the previous description, heretofore, only diffracted light from the diffraction areas A, B, AA, and BB have been received to perform generation of the lens error signal LE, push-pull signal PP, and focus error signal FE.

With Embodiment 1 of the second embodiment, as compared to a case of being compatible with an multi-layer disc according to the related art (FIG. 21A), the area of the mask diffraction area Mc is reduced. With space generated by reduction thereof, the diffraction area C is then formed.

As illustrated in the drawing, the diffraction area C in this case is formed on each of the outer edges of facing two sides of the mask diffraction area Mc. Specifically, the diffraction area C is formed on each of the outer edges of two sides in the radial direction of the mask diffraction area Mc.

As illustrated in FIG. 23B, with the second light-receiving unit 14 in this case, in addition to a light-receiving element D formed on the second light-receiving unit 14 according to the related art illustrated in the previous FIGS. 5E and 21B, light-receiving elements D_p1j and D_m1j are newly formed.

Diffracted light according to the diffraction area C is received by each of these light-receiving elements D_p1j and D_m1j, and the received light signals at these light-receiving elements D_p1j and D_m1j are newly embedded in calculation of the focus error signal FE.

Specifically, when assuming that the received light signals at the light-receiving elements D_p1j and D_m1j are p1j, m1j respectively, the focus error signal FE in this case is calculated by the following Expression 4.

FE={(m1Ml+m1Mr+m1Nl+m1Nr+p1Zll+p1Zlr+p1Zr+p1j)−(m1Zl+m1Zr+p1Mll+p1Mlr+p1Mr+p1Nll+p1Nlr+p1Nr+m1j)} Expression 4

The focus error signal generating technique serving as the second embodiment as described above can be expressed, in other words, that with regard to light near the light flux center portion which has heretofore been scattered to a location other than light-receiving elements for suppressing quality deterioration of the lens error signal LE due to being compatible with a multi-layer disc, a portion thereof is newly received for generation of the focus error signal FE, and a received light signal thereof is embedded in calculation of the focus error signal FE.

Calculation of the focus error signal FE is performed using a portion of light of the light flux center portion which is important for generation of the focus error signal FE, and accordingly, improvement in the S-letter waveform can be realized as compared to the related art. That is to say, as a result thereof, improvement in stability of focus-on operation and improvement in servo properties can be realized.

On the other hand, with regard to the lens error signal LE, diffracted light according to the diffraction area C adjacent to the mask diffraction area Mc as described above can be received at the light-receiving unit for generation of the lens error signal, and accordingly, the same advantage as the mask diffraction area Mc compatible with a multi-layer disc according to the related art can be maintained. Accordingly, the same signal quality as the related art can be maintained regarding the lens error signal LE.

In this way, according to the present example, not only suppression of quality deterioration of the lens error signal LE but also suppression of deterioration of the S-letter waveform of the focus error signal FE can be realized.

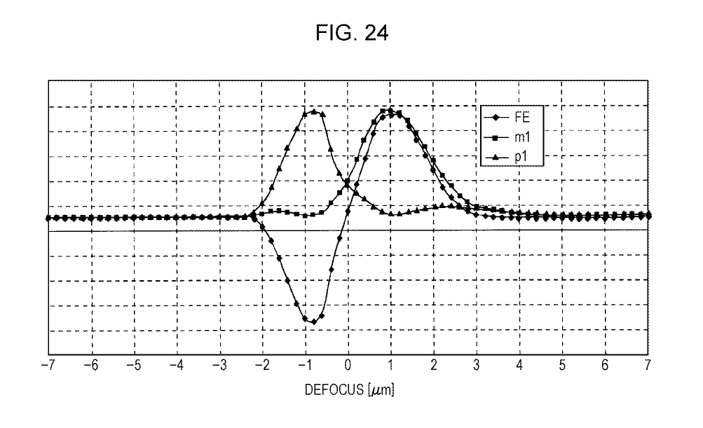

FIG. 24 is a diagram for describing a scene of improvement in the S-letter waveform of the focus error signal FE in the event of employing the focus error signal generating technique serving as the second embodiment described above.

Note that this FIG. 24 illustrates the waveforms of the focus error signal FE, m1 signal, and p1 signal at the time of performing focus search operation in the event of employing the focus error signal generating technique according to the second embodiment.

According to this FIG. 24, as compared to the related case illustrated in the previous FIG. 22, it can be found that distortion of the waveform of an intermediate section of the S-letter waveform of the focus error signal FE is suppressed, and linearity is improved. It can also be found from this result that stability of focus-on operation is improved, and also servo properties are improved.

### 3-3. Embodiment 2

Next, Embodiment 2 of the second embodiment will be described.

This Embodiment 2 enables light of a portion masked in the related art example compatible with a multi-layer disc to be used for not only generation of the focus error signal FE but also generation of the push-pull signal PP.

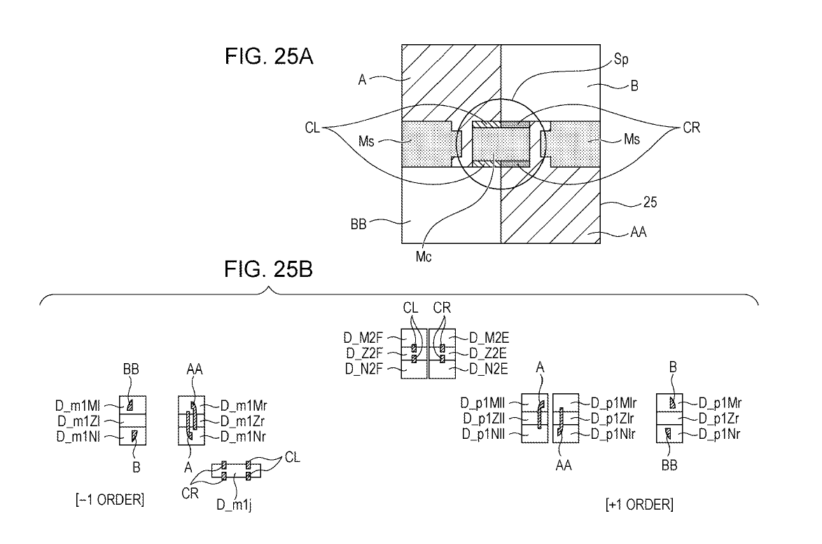

FIGS. 25A and 25B are diagrams for describing a signal generating technique serving as Embodiment 2 of the second embodiment, FIG. 25A illustrates a diffraction area formation pattern of the second beam splitting unit 25 included in an optical disc device serving as this Embodiment 2, and FIG. 25B illustrates a position relation between each of the light-receiving elements formed on the second light-receiving unit 14 included in the optical disc device according to this Embodiment 2 and the light-receiving spot of diffracted light according to the second beam splitting unit 25.

Note that, with this Embodiment 2, the internal configurations of the optical disc device are the same as those in FIGS. 1 and 2 except that the second beam splitting unit 25 is provided instead of the second beam splitting unit 12′, a light-receiving element which the second light-receiving unit 14 includes is that illustrated in FIG. 25B, and signal calculation by the focus error signal generating circuit 32 and push-pull signal generating circuit 34 differs, and accordingly redundant description will be omitted.

In FIG. 25A, the second beam splitting unit 25 in this Embodiment 2 differs from the second beam splitting unit 12 in the previous Embodiment 1 in that the diffraction area C is split into two in the radial direction to form a diffraction area CL and a diffraction area CR as illustrated in the drawing.

Specifically, these diffraction areas CL and CR are obtained by extending a split line between the diffraction areas A and B and a split line between the diffraction areas AA and BB to split the diffraction area C. In other words, these diffraction areas CL and CR are obtained by the diffraction area C being split by a split line in the tangential direction passing through the optical axis.

After the diffraction areas CL and CR are formed in this way, as to the second light-receiving unit 14 in this case, as illustrated in FIG. 25B, in addition to the light-receiving element D formed on the second light-receiving unit 14 according to the related art illustrated in the previous FIGS. 5E and 21B, newly light-receiving elements D_M2F, D_Z2F, D_N2F, D_M2E, D_Z2E, D_N2E, and D_m1j are formed.

Here, a position relation between these light-receiving elements D and the light-receiving spots of diffracted lights by the diffraction areas CL and CR is as follows.

[+1 Order Light Side]

D_M2F . . . A portion of CL on the upper side of space

D_Z2F . . . The remaining portion of CL on the upper side of space & a portion of CL on the lower side of space

D_N2F . . . The remaining portion of CL on the lower side of space

D_M2E . . . A portion of CR on the upper side of space

D_Z2E . . . The remaining portion of CR on the upper side of space & a portion of CR on the lower side of space

D_N2E . . . The remaining portion of CR on the lower side of space

[−1 Order Light Side]

D_m1j . . . CL & CR

According to the above-mentioned correspondence relation, the diffracted lights from the diffraction areas CL and CR are received at the light-receiving elements D_M2F, D_Z2F, D_N2F, D_M2E, D_Z2E, D_N2E, and D_m1j, and received light signals thereof are newly embedded in calculation of the focus error signal FE, and also newly embedded in calculation of the push-pull signal PP.

Specifically, when assuming that the received light signals by the light-receiving elements D_M2F, D_Z2F, D_N2F, D_M2E, D_Z2E, D_N2E, and D_m1j are M2F, Z2F, N2F, M2E, Z2E, N2E, and m1j, the focus error signal FE in this case is calculated by the following Expression 5.

FE={(m1Ml+m1Mr+m1Nl+m1Nr+p1Zll+p1Zlr+p1Zr+Z2F+Z2E)−(m1Zl+m1Zr+p1Mll+p1Mlr+p1Mr+p1Nll+p1Nlr+p1Nr+m1j)} Expression 5

Also, the push-pull signal PP is calculated by the following Expression 6.

PP={(p1Mll+p1Zll+p1Nll+p1Nr+M2F+Z2F+N2F)−(p1Mlr+p1Zlr+p1Nlr+p1Mr+M2E+Z2E+N2E)} Expression 6

As described above, with Embodiment 2 of the second embodiment, the mask diffraction area Mc compatible with a multi-layer disc according to the related art is reduced, diffracted light from the diffraction area C formed as to space generated by this reduction is received, and a received light signal is embedded in calculation of the push-pull signal PP. Thus, the amplitude property and field property of the push-pull signal PP, position shift tolerance, and so forth can be improved, and improvement in servo properties is realized.

Incidentally, with the description so far of the second embodiment, though a case has been exemplified where the optical disc device irradiates a laser beam with a single wavelength, it goes without saying that the optical disc device according to the second embodiment may also be configured so as to irradiate a laser beam according to multiple wavelengths.

As described above as well, with the second beam splitting unit side which performs beam splitting using diffraction, in order to perform reception of reflected light and generation of a signal regarding laser beams having different wavelengths, a light-receiving element is provided for each wavelength at the second light-receiving unit 14. This is because the diffraction angle at the second beam splitting unit differs for each wavelength.

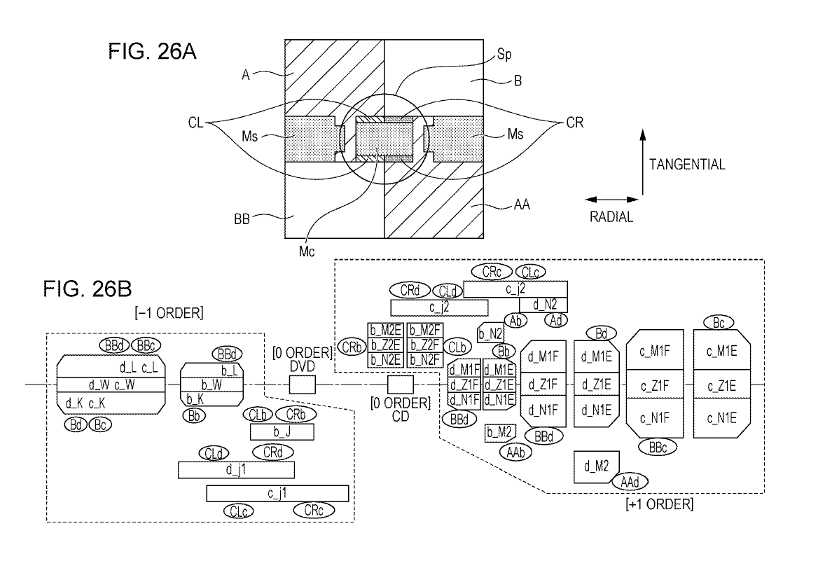

FIGS. 26A and 26B illustrate a diffraction area formation pattern of the second beam splitting unit 25 in order to handle three wavelengths for BD, DVD, and CD (FIG. 26A), and a position relation between each of the light-receiving elements formed on the second light-receiving unit 14 and the light-receiving spot of diffracted light by the second beam splitting unit 25 (FIG. 26B).

Here, as for the configuration of an optical pickup compatible with three wavelengths, the same as illustrated in the previous FIG. 13, for example, may be employed.

First, as a premise, with the configuration compatible with three wavelengths for BD, DVD, and CD, it is common that as for the second beam splitting unit 25 serving as an HOE, so-called design for BD is employed so as to obtain the maximum diffraction efficiency as to the wavelength for BD (e.g., 405 nm or so).

In the event of employing design for BD, when playing a two-layer DVD disc, 0 order light (0 order light from the second beam splitting unit 25) regarding stray light from the recording layer on the near side of this DVD exists with significant intensity, and accordingly, what is of paramount importance is that the light-receiving element for DVD is disposed so as to avoid this.

The diffraction area formation pattern of the second beam splitting unit 25 in the case of being compatible with three wavelengths, and the formation pattern of each light-receiving element in the second light-receiving unit 14 have to be set so as to avoid stray light (0 order light) of such a 2-layer DVD.

Also, when setting the diffraction area formation pattern of the second beam splitting unit 25 and the formation pattern of each light-receiving element in the second light-receiving unit 14, it has to be taken into consideration that with regard to each laser beam for BD and DVD (i.e., a laser beam compatible with a standard having two or more recording layers wherein another layer stray light may occur), stray light serving as 1 order diffracted light (according to the second beam splitting unit 25) stray light serving as 1 order diffracted light is prevented from being overlapped with the received light area of 1 order diffracted light (according to the second beam splitting unit 25) of reflected light from the recording layer to be processed.

Specifically, though it is arranged here to perform generation of the lens error signal LE and push-pull signal PP employing +1 order light alone, in this case, it has also to be taken into consideration for realizing suitable signal generation to prevent +1 order stray light for BD and DVD from affecting on the light-receiving elements of +1 order lights for BD and DVD.

In FIG. 26A, with the second beam splitting unit 25 in this case, as compared to the second beam splitting unit 25 illustrated in the previous FIG. 25A, the position relation between the diffraction areas A and BB, and the position relation between the diffraction areas B and AA are reversed in the tangential direction, respectively.

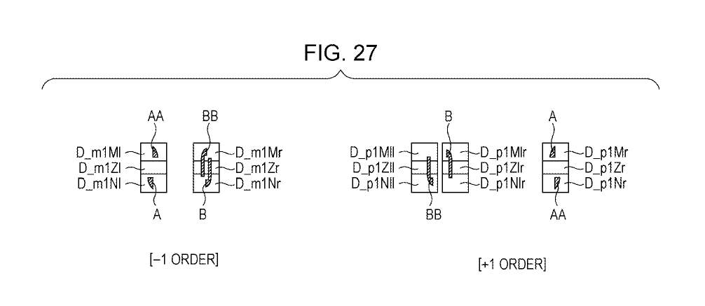

Now, there is illustrated in FIG. 27 a position relation between each light-receiving element of the second light-receiving unit 14 and the light-receiving spot of diffracted light according to the second beam splitting unit 25 in the event that the position relation between the diffraction areas A and BB, and the position relation between the diffraction areas B and AA are reversed in this way.

Note that FIG. 27 illustrates, in a manner comparable with the previous FIG. 25B, the light-receiving elements D illustrated in FIG. 25B as light-receiving elements to be formed on the second light-receiving unit 14. Note that, as for the light-receiving elements D, of all of the light-receiving elements illustrated in FIG. 25B, only the light-receiving elements D (D_p1Mll, D_p1Zll, D_p1Nll, D_p1Mlr, D_p1Zlr, D_p1Nlr, D_p1Mr, D_p1Zr, and D_p1Nr) relating to switching of diffraction patterns are extracted and illustrated.

In the event of having set a diffraction area formation pattern as illustrated in FIG. 26A, correspondence between diffracted light according to each diffraction area and each light-receiving element is as follows.

[+1 Order Light Side]

D_p1Mll . . . The upper side portion of BB (small amount)

D_p1Zll . . . The upper portion of BB

D_p1Nll . . . The lower portion of BB

D_p1Mlr . . . The upper portion of B

D_p1Zlr . . . The lower portion of B

D_p1Nlr . . . The lower side portion of B (small amount)

D_p1Mr . . . A

D_p1Zr . . . None

D_p1Nr . . . AA

[−1 Order Light Side]

D_m1Ml . . . AA

D_m1Zl . . . None

D_m1Nl . . . A

D_m1Mr . . . The lower portion of BB & the lower side portion of B (small amount)

D_m1Zr . . . The upper portion of BB & the lower portion of B

D_m1Nr . . . The upper side portion of BB (small amount) & upper portion of B

Description will be returned to FIGS. 26A and 26B.

As illustrated in FIG. 26B, with the second light-receiving unit 14 in this case, a light-receiving element for receiving reflected light of each of BD, DVD, and CD is formed.

First, with the second light-receiving unit 14 in this case, there are provided light-receiving elements for receiving 0 order lights by the second beam splitting unit 25 regarding the reflected lights for DVD and CD.

In the event that the second beam splitting unit 25 has been designed for BD, 0 order lights regarding the reflected lights for DVD and CD are emitted from the second beam splitting unit 25. As can be understood from the description so far, with the present embodiment, generation of various signals is arranged to be performed using ±1 order light, and accordingly, the 0 order lights of DVD and CD which are used for signal generation are absorbed by providing light-receiving elements which receive these to prevent scattering, and to prevent leakage to another light-receiving element.

With the second light-receiving unit 14 in this case, as light-receiving elements regarding +1 order light for BD, there are formed light-receiving elements b_MIF, b_ZIF, b_N1F, b_M1E, b_Z1E, b_N1E, b_N2, b_M2, b_M2E, b_Z2E, b_N2E, b_M2F, b_Z2F, and b_N2F.

Also, as light-receiving elements regarding +1 order light for DVD, there are formed light-receiving elements d_MIF, d_ZIF, d_N1F, d_M1E, d_ZIE, d_N1E, d_N2, d_M2, and d_j2.

Further, as light-receiving elements regarding +1 order light for CD, there are formed light-receiving elements c_MIF, c_ZIF, c_N1F, c_MIE, c_ZIE, c_N1E, and c_j2.

Also, as light-receiving elements regarding −1 order light for BD, there are formed light-receiving elements b_L, b_W, b_K, and b_j.

Also, as light-receiving elements regarding −1 order light for DVD, there are formed light-receiving elements “d_L, c_L” “d_W, c_W” “d_K, c_K” and d_j1.

Further, as light-receiving elements regarding −1 order light for CD, there are formed light-receiving elements “d_L, c_L” “d_W, c_W” “d_K, c_K” and c_j1.

Note that each of the light-receiving elements “d_L, c_L” “d_W, c_W” “d_K, c_K” is a light-receiving element to be shared by DVD and CD.

A correspondence relation between diffracted light according to each diffraction area of the second beam splitting unit 25 in this case and each light-receiving element in the second light-receiving unit 14 is as follows.

[BD +1 Order Light Side]

b_MIF . . . The upper side portion of BB (small amount)

b_ZIF . . . The upper portion of BB

b_N1F . . . The lower portion of BB

b_M1E . . . The upper portion of B

b_Z1E . . . The lower portion of B

b_N1E . . . The lower side portion of B (small amount)

b_N2 . . . A

b_M2 . . . AA

b_M2F . . . A portion of CL on the upper side of space

b_Z2F . . . The remaining portion of CL on the upper side of space & a portion of CL on the lower side of space

b_N2F . . . The remaining portion of CL on the lower side of space

b_M2E . . . A portion of CR on the upper side of space

b_Z2E . . . The remaining portion of CR on the upper side of space & a portion of CR on the lower side of space

b_N2E . . . The remaining portion of CR on the lower side of space

[BD −1 Order Light Side]

b_L . . . The lower portion of BB & the lower side portion of B (small amount)

b_W . . . The upper portion of BB & the lower portion of B

b_K . . . The upper side portion of BB (small amount) & the upper portion of B

b_j . . . CL & CR

[DVD+1 Order Light Side]

d_MIF . . . The upper side portion of BB (small amount)

d_ZIF . . . The upper portion of BB

d_N1F . . . The lower portion of BB

d_M1E . . . The upper portion of B

d_Z1E . . . The lower portion of B

d_N1E . . . The lower side portion of B (small amount)

d_N2 . . . A

d_M2 . . . AA

d_j2 . . . CL & CR

[DVD −1 Order Light Side]

d_L . . . The lower portion of BB & the lower side portion of B (small amount)

d_W . . . The upper portion of BB & the lower portion of B

d_K . . . The upper side portion of BB (small amount) & the upper portion of B

d_j1 . . . CL & CR

[CD +1 Order Light Side]

c_MIF . . . The upper side portion of BB (small amount)

c_ZIF . . . The upper portion of BB

c_N1F . . . The lower portion of BB

c_M1E . . . The upper portion of B

c_Z1E . . . The lower portion of B

c_N1E . . . The lower side portion of B (small amount)

c_j2 . . . CL & CR

[CD −1 Order Light Side]

c_L . . . The lower portion of BB & the lower side portion of B (small amount)

c_W . . . The upper portion of BB & the lower portion of B

c_K . . . The upper side portion of BB (small amount) & the upper portion of B

c_j1 . . . CL & CR

With correspondence with the light-receiving elements illustrated in FIG. 25B, the light-receiving elements b_L, b_W, and b_K in the drawing are equivalent to the light-receiving elements D_m1Mr, D_m1Zr, and D_m1Nr regarding BD, respectively. Also, the light-receiving elements “d_L, c_L” “d_W, c_W” and “d_K, c_K” are equivalent to the light-receiving elements D_m1Mr, D_m1Zr, and D_m1Nr regarding DVD and CD, respectively.

Also, the light-receiving element b_j is equivalent to the light-receiving element D_m1j regarding BD, the light-receiving element d_j1 is equivalent to the light-receiving element D_m1j regarding DVD, and the light-receiving element c_j1 is equivalent to the light-receiving element D_m1j regarding CD.

Also, the light-receiving elements b_MIF, b_ZIF, b_N1F, b_MIE, b_ZIE, and b_N1E are equivalent to the light-receiving elements D_p1Mll, D_p1Zll, D_p1Nll, D_p1Mlr, D_p1Zlr, and D_p1Nlr regarding BD respectively, the light-receiving elements d_MIF, d_ZIF, d_N1F, d_MIE, d_ZIE, and d_N1E are equivalent to the light-receiving elements D_p1Mll, D_p1Zll, D_p1Nll, D_p1Mlr, D_p1Zlr, and D_p1Nlr regarding DVD respectively, and the light-receiving elements c_MIF, c_ZIF, c_N1F, c_MIE, c_ZIE, and c_N1E are equivalent to the light-receiving elements D_p1Mll, D_p1Zll, D_p1Nll, D_p1Mlr, D_p1Zlr, and D_p1Nlr regarding CD respectively.

Also, the light-receiving elements b_N2 and b_M2 are equivalent to the light-receiving elements D_p1Mr and D_p1Nr regarding BD respectively, and the light-receiving elements d_N2 and d_M2 are equivalent to the light-receiving elements D_p1Mr and D_p1Nr regarding DVD respectively.

Also, the light-receiving elements b_M2E, b_Z2E, and b_N2E are equivalent to the light-receiving elements D_M2E, D_Z2E, and D_N2E regarding BD respectively, and the light-receiving elements b_M2F, b_Z2F, and b_N2F are equivalent to the light-receiving elements D_M2F, D_Z2F, and D_N2F regarding BD respectively.

Also, the light-receiving element d_j2 is equivalent to the light-receiving element D_Z2F and light-receiving element D_Z2E regarding DVD, and the light-receiving element c_j2 is equivalent to the light-receiving element D_Z2F and light-receiving element D_Z2E regarding CD.

Now, in FIG. 26B, as compared to the previous FIG. 25B, though the received light position of the diffracted light according to the diffraction area CL, and the received light position of the diffracted light according to the diffraction area CR are reversed in the radial direction, this is one solution derived when considering the diffraction area formation pattern and light-receiving element formation pattern whereby influence of stray light as described above can be suppressed.

After setting the correspondence relation between the diffracted light of each diffraction area of the second beam splitting unit 25 and each light-receiving element in the second light-receiving unit 14 as described above, with the optical disc device in this case, various signals are generated as follows.

First, with regard to BD, the focus error signal FE, lens error signal LE, and push-pull signal PP are generated as follows.

FE={(b_{—}L+b_{—}K+b_{—}Z1E+b_{—}Z1F+b_{—}Z2E+b_{—}Z2F)−(b_{—}M1E+bM1F+bN1E+bN1F+bW+bj)} Expression 7

LE={(b_{—}M1E+b_{—}M1F+b_{—}M2)−(b_{—}N1E+b_{—}N1F+b_{—}N2)} Expression 8

PP={(b_{—}M1E+b_{—}N1E+b_{—}Z1E+b_{—}M2+b_{—}M2E+b_{—}N2E+b_{—}Z2E)−(b_{—}M1F+b_{—}N1F+b_{—}Z1F+b_{—}N2+b_{—}M2F+b_{—}N2F+b_{—}Z2F)} Expression 10

Also, with regard to DVD, the focus error signal FE, lens error signal LE, and push-pull signal PP are generated as follows.

FE={(d_{—}L+d_{—}K+d_{—}Z1E+d_{—}Z1F+d_{—}j2)−(d_{—}M1E+d_{—}M1F+d_{—}N1E+d_{—}N1F+dW+dj1)} Expression 11

LE={(d_{—}M1E+d_{—}M1F+d_{—}M2)−(d_{—}N1E+d_{—}N1F+d_{—}N2)} Expression 12

PP={(d_{—}M1E+d_{—}N1E+d_{—}Z1E+d_{—}M2)−(d_{—}M1F+d_{—}N1F+d_{—}Z1F+d_{—}N2)} Expression 13

Also, with regard to CD, the focus error signal FE is generated as follows.

FE={(cL+cK+cj2)−(c_{—}M1F+cM1E+cN1F+c_{—}N1E+c_{—}j1)} Expression 14

Incidentally, as can be understood from the description so far, though the second embodiment realizes suppression of property deterioration of the focus error signal FE caused due to the light of the light flux center portion being markedly removed by expanding the mask diffraction area Mc for being compatible with a multi-layer disc, the property deterioration of the focus error signal FE accompanying expansion of the mask diffraction area Mc markedly emerges regarding light obliquely input to the second beam splitting unit, e.g., such as CD having a configuration compatible with three waveforms exemplified in Embodiment 2.

With light to be obliquely input in this way, the incident spot to the second beam splitting unit is formed in a position shifted as to the incident spots of BD and DVD, and accordingly, light in a range with a position shifted from the optical axis as the center is removed by the mask diffraction area Mc, and consequently, pertinent signals are markedly removed. Also, in particular, with CD having a configuration compatible with three wavelengths of oblique input exemplified above, the spot diameter of a laser beam for CD is relatively small (small due to NA restriction of an objective lens compatible with multiple wavelengths), and accordingly, the size of the mask diffraction area Mc as to the spot is relatively great as compared to BD and DVD, and in this point as well, pertinent signals are markedly removed.

Upon considering such a situation, it can be found that, as indicated in the previous Expression 14, if calculation of the focus error signal FE using diffracted light of the diffraction area C is also performed on CD, the property deterioration of the focus error signal FE regard CD (oblique incidence) can effectively be suppressed.

Note that, with a configuration compatible with multiple wavelengths as described with FIGS. 26A and 26B, the light-receiving elements in the second light-receiving unit 14 are disposed in a two-dimensional manner, i.e., disposed so as to avoid overlapping of light-receiving units regarding the wavelengths as much as possible, whereby calculation of various types of signals of the focus error signal FE, lens error signal LE, and push-pull signal PP can readily be performed while suppressing the number of I-V conversion amplifiers as less as possible.

Also, the BD, DVD, and CD are not simultaneously operated, and accordingly, the number of I-V conversion amplifiers can be suppressed by switching light-receiving elements which perform the same operation so as to be used by the same I-V conversion amplifier. If the number of amplifiers is suppressed, consumption current and chip area can also be suppressed, which contributes to reduction in costs.

### 4. Modification

Though the embodiments according to the present technology have been described so far, the present technology is not restricted to the above-mentioned specific examples.

For example, with the description so far, with employing the spot size method as a premise, the received light signal regarding diffracted light according to the diffraction area C has been embedded in generation of the focus error signal FE according to the spot size method, but the present technology may be applied to a case where the Foucault method is employed. That is to say, the received light signal regarding diffracted light according to the diffraction area C can be embedded in generation of the focus error signal according to the Foucault method.

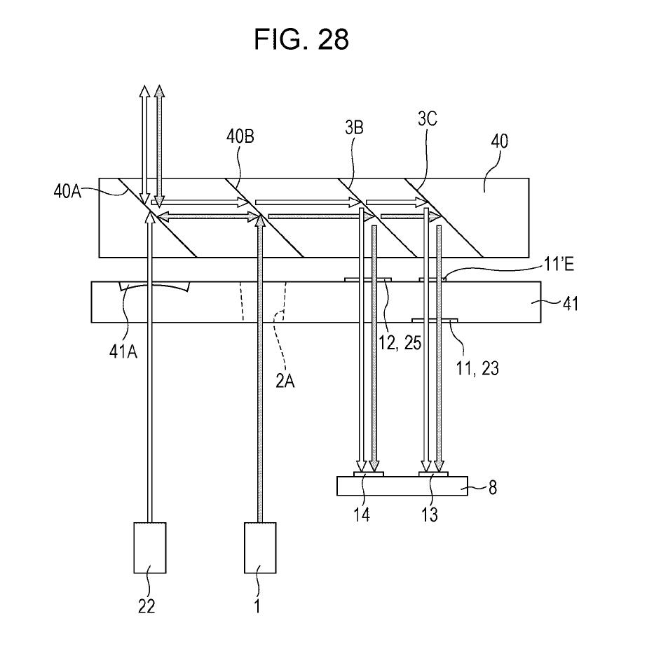

Also, with the description so far, in order to realize the configuration compatible with three wavelengths for BD, DVD, and CD, as illustrated in FIG. 13, though the dichroic prism 21 is provided separately from the laminating prism 3 to compound the laser beams of the DVD and CD systems as to the BD system, the dichroic prism 21 can be omitted by providing the laminated prism 40 to which a compound wave function has been provided as illustrated in the next FIG. 28.

FIG. 28 is a diagram for describing the internal configuration of an optical disc device serving as a modification including the laminated prism 40 to which the compound wave function has been provided.

Note that, in this FIG. 28, of the internal configuration of the optical pickup included in the optical disc device serving as this modification, only a potion different from the configuration described with the previous FIG. 13 is extracted and illustrated.

As illustrated in the drawing, with the optical pickup in this case, there are provided the laminated prism 40 instead of the laminated prism 3, and a compound lens 41 instead of the compound lens 2.

As illustrated in the drawing, with the compound lens 41, there are formed a through hole 2A through which the laser beam for BD emitted from the BD laser 1 passes, a first beam splitting unit 11 (or 23), a second beam splitting unit 12 (or 25), and a diffraction element 11′E.

With the compound lens 41 in this case, a coupling lens 41A is formed, and the laser beam for DVD and laser beam for CD emitted from the DVD and CD laser 22 are input to the laminated prism 40 via this coupling lens 41A.

With the laminated prism 40, the half-reflection film 3B and total reflection film 3C which the laminated prism 3 includes are formed, and also a wavelength selectivity polarization selective reflection film 40A and a wavelength selectivity polarization selective reflection film 40B are formed.

These wavelength selectivity polarization selective reflection films 40A and 40B serve as polarization beam splitters as to the light of the wavelength band for BD, and serve as generally non-polarization beam splitters as to the lights of other wavelength bands.

The laser beam for BD emitted from the BD laser 1 and input to the laminated prism 40 via the through hole 2A is guided to the wavelength selectivity polarization selective reflection film 40B, part of light based on a percentage according to the polarization state thereof is reflected at this wavelength selectivity polarization selective reflection film 40B, and is guided to the wavelength selectivity polarization selective reflection film 40A.

The laser beam for BD guided to the wavelength selectivity polarization selective reflection film 40A in this way is generally total-reflected at this wavelength selectivity polarization selective reflection film 40A, and input to the collimating lens 4 of which drawing is omitted here.

On the other hand, the reflected light of the laser beam for BD input to the wavelength selectivity polarization selective reflection film 40A via the collimating lens 4 as return trip light is reflected at this wavelength selectivity polarization selective reflection film 40A, and guided to the wavelength selectivity polarization selective reflection film 40B, and transmits this wavelength selectivity polarization selective reflection film 40B.

Also, the laser beam for DVD and laser beam for CD emitted from the DVD and CD laser 22 and passed through the coupling lens 41A are input to the wavelength selectivity polarization selective reflection film 40A, and a portion thereof transmits this wavelength selectivity polarization selective reflection film 40A and inputs to the collimating lens 4.

Of the reflected lights of the laser beam for DVD and laser beam for CD input to the wavelength selectivity polarization selective reflection film 40A via the collimating lens 4 as return trip lights, a portion thereof is reflected at this wavelength selectivity polarization selective reflection film 40A, and guided to the wavelength selectivity polarization selective reflection film 40B.

Of the reflected lights of the laser beam for DVD and laser beam for CD guided to the wavelength selectivity polarization selective reflection film 40B in this way, a portion thereof transmits this wavelength selectivity polarization selective reflection film 40B.

The reflected lights of the laser beam for BD, laser beam for DVD, and laser beam for CD which transmitted the wavelength selectivity polarization selective reflection film 40B are guided to the half-reflection film 3B.

Note that, in this case as well, the light reflected at the half-reflection film 3B is received by the second light-receiving unit 14 via the second beam splitting unit 12 (or 25), the light which transmitted the half-reflection film 3B and reflected at the total reflection film 3C is received by the first light-receiving unit 13 via the diffraction element 11′E→the first beam splitting unit 12 (or 23), which is the same as the case of the previous embodiments.

Also, with the description so far, with the configuration compatible with three waveforms, though a case has been exemplified where one common objective lens 6 is employed, a configuration individually including an objective lens for BD and objective lens for DVD and CD may also be employed.

Also, with the previous first embodiment, though the laser beams for BD and DVD have been input to the first beam splitting unit (11 or 23) as multiple wavelength lights having the same optical axis, there may also be a configuration wherein according to a combination of BD and CD or a combination of DVD and CD, these lights are input to the first beam splitting unit by the same optical axis.

Also, the present technology may also be configured as follows.

(1) An optical disc device including: a diffraction element to which reflected light from an optical disc recording medium is input, including a first diffraction area formed in a position where light in the center portion of incident light flux is diffracted, a second diffraction area formed so as to be in contact with an outer edge of the first diffraction area, and a third diffraction area formed so as to be in contact with an outer edge of the second diffraction area; and a light receiving/signal generating unit configured to perform generation of a focus error signal and generation of a lens error signal based on light diffracted at the third diffraction area; wherein the light receiving/signal generating unit receives light diffracted at the second diffraction area, and performs generation of the focus error signal based on the received light signal thereof and a received light signal obtained by receiving light diffracted at the third diffraction area.

(2) The optical disc device according to (1) or (2), wherein the diffraction areas in the diffraction element are configured so as to provide difference in a focal position in the tangential direction to +1 order diffracted light and −1 order diffracted light according to an effect serving as a cylindrical lens; and wherein the light receiving/signal generating unit generates the focus error signal based on a result after performing calculation for comparing the light-receiving spot sizes of +1 order diffracted light and −1 order diffracted light to be output from the diffraction areas.

(3) The optical disc device according to (1) or (2), wherein the light receiving/signal generating unit performs generation of a push-pull signal based on light diffracted at the third diffraction area and also light diffracted at the second diffraction area.

(4) The optical disc device according to (3), wherein both of the second diffraction area and the third diffraction area are split into two in the radial direction; and wherein, when assuming that received light signals regarding lights diffracted at diffraction areas formed on one side in the radial direction of the second diffraction area and the third diffraction area are taken as D2_{—}1 and D3_{—}1, and received light signals regarding lights diffracted at diffraction areas formed on the other side in the radial direction of the second diffraction area and the third diffraction area are taken as D2_{—}2 and D3_{—}2, the light receiving/signal generating unit performs calculation represented with

(D3_{—}1+D2_{—}1)−(D3_{—}2+D2_{—}2)

to generate the push-pull signal.

The present disclosure contains subject matter related to that disclosed in Japanese Priority Patent Application JP 2011-238469 filed in the Japan Patent Office on Oct. 31, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical disc device comprising:
a diffraction element to which reflected light from an optical disc recording medium is input, including
a first diffraction area formed in a position where light in the center portion of incident light flux is diffracted,
a second diffraction area formed so as to be in contact with an outer edge of the first diffraction area, and
a third diffraction area formed so as to be in contact with an outer edge of the second diffraction area; and
a light receiving/signal generating unit configured to perform generation of a focus error signal and generation of a lens error signal based on light diffracted at the third diffraction area;
wherein the light receiving/signal generating unit receives light diffracted at the second diffraction area, and performs generation of the focus error signal based on the received light signal thereof and a received light signal obtained by receiving light diffracted at the third diffraction area.

2. The optical disc device according to claim 1, wherein the diffraction areas in the diffraction element are configured so as to provide difference in a focal position in the tangential direction to +1 order diffracted light and −1 order diffracted light according to an effect serving as a cylindrical lens;
and wherein the light receiving/signal generating unit generates the focus error signal based on a result after performing calculation for comparing the light-receiving spot sizes of +1 order diffracted light and −1 order diffracted light to be output from the diffraction areas.

3. The optical disc device according to claim 1, wherein the light receiving/signal generating unit performs generation of a push-pull signal based on light diffracted at the third diffraction area and also light diffracted at the second diffraction area.

4. The optical disc device according to claim 3, wherein both of the second diffraction area and the third diffraction area are split into two in the radial direction;
and wherein, when assuming that received light signals regarding lights diffracted at diffraction areas formed on one side in the radial direction of the second diffraction area and the third diffraction area are taken as D2_{—}1 and D3_{—}1, and received light signals regarding lights diffracted at diffraction areas formed on the other side in the radial direction of the second diffraction area and the third diffraction area are taken as D2_{—}2 and D3_{—}2,
the light receiving/signal generating unit performs calculation represented with
(D3_{—}1+D2_{—}1)−(D3_{—}2+D2_{—}2)
to generate the push-pull signal.
